(19) United States
(12) Patent Application Publication
(10) Pub. No.: US 2014/0350179 A1
(43) Pub. Date: Nov. 27, 2014

(54) LIQUID CRYSTAL ALIGNMENT AGENT, LIQUID CRYSTAL ALIGNMENT FILM AND LIQUID CRYSTAL DISPLAY ELEMENT HAVING THEREOF

(71) Applicant: CHI MEI CORPORATION, Tainan City (TW)

(72) Inventor: Tsung-Pei TSAI, TAINAN CITY (TW)

(73) Assignee: CHI MEI CORPORATION, Tainan City (TW)

(21) Appl. No.: 14/267,906

(22) Filed: May 1, 2014

(30) Foreign Application Priority Data
May 22, 2013 (TW) 102118079

(51) Int. Cl. G02F 1/1337

(52) U.S. Cl. CPC G02F 1/133723
USPC 524/600

(57) ABSTRACT

The present invention relates to a liquid crystal alignment agent, a liquid crystal alignment film made by the liquid crystal alignment agent and a liquid crystal display element having the liquid crystal alignment film. The liquid crystal alignment agent includes a polymer composition (A) and a solvent (B). The polymer composition (A) is synthesized by reacting a mixture that includes a tetracarboxylic dianhydride component (a) and a diamine component (b). The aforementioned liquid crystal alignment agent has a better long-term printability.

### RELATED APPLICATIONS

This application claims priority to Taiwan Application Serial Number 102118079, filed on May 22, 2013, which is herein incorporated by reference.

### BACKGROUND

1. Field of Invention

The present invention relates to a liquid crystal alignment agent, a liquid crystal alignment film and a liquid crystal display element having thereof. More particularly, the present invention relates a liquid crystal alignment agent that has an excellent long-term printability, a liquid crystal alignment film formed by the liquid crystal alignment agent, and a liquid crystal display element comprises the liquid crystal alignment film.

2. Description of Related Art

In recent years, there is a requirement of the wide view angle of the liquid crystal display element, thus the requirements of the electrical properties and display properties have become stiffer. In wide view angle liquid crystal display element, vertical alignment liquid crystal display element is widely studied. For meeting better electrical properties and display properties, liquid crystal alignment film becomes the important factor.

The liquid crystal alignment film of the vertical alignment liquid crystal display element is used to regularly align the liquid crystal molecule, and provide a bigger pretilt angle to the liquid crystal molecule when the electrical field is not applied. For producing the aforementioned liquid crystal alignment film, a liquid crystal alignment agent having polyamic acid or polyimide is firstly coated on a surface of the substrate. Then, thermal treatment and an alignment treatment are performed, thereby obtaining the liquid crystal alignment film.

JP2002-162630 discloses a polyamic acid polymer for producing the liquid crystal alignment agent of vertical alignment liquid crystal display element.

The polyamic acid polymer is synthesized by polymerizing a diamine compound having a structure of formula (IV) and tetracarboxylic dianhydride compound:

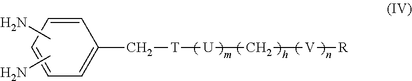

in the formula (IV), T, U and V are respectively benzene or cyclohexanone, and hydrogen atom in benzene and cyclohexanone can be substituted by alkyl group of 1 to 3 carbons or alkyl group of 1 to 3 carbons substituted by fluoro atom, chloro atom or cyano group; m and n respectively are integer of 0 to 2; h is an integer of 0 to 5; R is an monovalent organic group, such as a hydrogen atom, a fluoro atom, a chloro atom or a cyano group. When m is 2 or n is 2, two U or two V can be the same or different.

The aforementioned liquid crystal alignment film can provide about 90° of pretilt angle, so as to obtain good liquid crystal alignment properties. However, when the liquid crystal alignment agent applied in long-term printing by industrial printer to proceed mass production, the liquid crystal alignment agent easily has defects of particles precipitation and agent accumulation, thereby unsatisfying the requirements.

Accordingly, there is a need to improve the aforementioned disadvantages for the requirements of the liquid crystal alignment agent.

### SUMMARY

Therefore, an aspect of the present invention provides a liquid crystal alignment agent. The liquid crystal alignment agent comprises a polymer composition (A) and a solvent (B). The liquid crystal alignment agent can improve the defects of the long-term printability.

Another aspect of the present invention provides a liquid crystal alignment film. The liquid crystal alignment film is formed by the aforementioned liquid crystal alignment agent.

A further aspect of the present invention provides a liquid crystal display element. The liquid crystal display element includes the aforementioned liquid crystal alignment film.

The liquid crystal alignment agent comprising the polymer composition (A) and the solvent (B) all of which are described in details as follows.

### Polymer Composition (A)

The polymer composition (A) is selected from the group consisting of polyamic acid, polyimide, polyimide series block-copolymer and a combination thereof. The polyimide series block-copolymer is selected from the group consisting of polyamic acid block-copolymer, polyimide block-copolymer, polyamic acid-polyimide block-copolymer and a combination thereof.

The polyamic acid, polyimide, and polyimide series block-copolymer of the polymer composition (A) all synthesized by reacting a mixture that includes a tetracarboxylic dianhydride component (a) and a diamine component (b). The tetracarboxylic dianhydride component (a), the diamine component (b) and a method of producing the polymer composition (A) all of which are described in details as follows.

### Tetracarboxylic Dianhydride Component (a)

The tetracarboxylic dianhydride component (a) can be selected from the group consisting of an aliphatic tetracarboxylic dianhydride compound, an alicyclic tetracarboxylic dianhydride compound, an aromatic tetracarboxylic dianhydride compound, the tetracarboxylic dianhydride component (a) having a structure of formula (V-1) to (V-6) and the like.

For example, the aliphatic tetracarboxylic dianhydride compound includes but is not limited tetracarboxylic dianhydride ethane, tetracarboxylic dianhydride butane and the like.

For example, the alicyclic tetracarboxylic dianhydride compound includes but is not limited 1,2,3,4-tetracarboxylic dianhydride cyclobutane, 1,2-dimethyl-1,2,3,4-tetracarboxylic dianhydride cyclobutane, 1,3-dimethyl-1,2,3,4-tetracarboxylic dianhydride cyclobutane, 1,3-dichloro-1,2,3,4-tetracarboxylic dianhydride cyclobutane, 1,2,3,4-tetramethyl-1,2,3,4-tetracarboxylic dianhydride cyclobutane, 1,2,3,4-tetracarboxylic dianhydride cyclopentane, 1,2,4,5-tetracarboxylic dianhydride cyclohexane, 3,3′,4,4′-tetracarboxylic dianhydride dicyclohexane, cis-3,7-dibutylcycloheptyl-1,5-diene-1,2,5,6-tetracarboxylic dianhydride, 2,3,5-tricarboxycyclopentyl acetic dianhydride, dicyclo[2.2.2]-octyl-7-ene-2,3,5,6-tetracarboxylic dianhydride and the like.

For example, the aromatic tetracarboxylic dianhydride compound includes but is not limited 3,4-dicarboxy-1,2,3,4-tetrahydronaphthalene-1-succinic acid dianhydride, pyromellitic dianhydride, 2,2′,3,3′-benzophenone tetracarboxylic dianhydride. 3,3′,4,4′-benzophenone tetracarboxylic dianhydride.

3,3′,4,4′-biphenylsulfone tetracarboxylic dianhydride, 1,4,5,8-naphthalene tetracarboxylic dianhydride, 2,3,6,7-naphthalene tetracarboxylic dianhydride, 3,3′,4,4′-biphenylethane tetracarboxylic dianhydride, 3,3′,4,4′-dimethyl diphenylsilane tetracarboxylic dianhydride, 3,3′,4,4′-tetraphenylsilane tetracarboxylic dianhydride, 1,2,3,4-furan tetracarboxylic dianhydride, 2,3,3′,4′-biphenylether tetracarboxylic dianhydride, 3,3′,4,4′-biphenylether tetracarboxylic dianhydride, 4,4′-bis(3,4-dicarboxyphenoxy)diphenylsulfide dianhydride, 2,3,3′,4′-biphenylsulfide tetracarboxylic dianhydride, 3,3′,4,4′-biphenylsulfide tetracarboxylic dianhydride, 4,4′-bis(3,4-dicarboxyphenoxyl)diphenylsulfone dianhydride, 4,4′-bis(3,4-dicarboxyphenoxyl)diphenylpropane dianhydride, 3,3′,4,4′-perfluoroisopropylidene diphenyl dicarboxylic dianhydride, 2,2′3,3′-biphenyl tetracarboxylic dianhydride, 2,3,3′,4′-biphenyl tetracarbxylic dihydrate, 3,3′,4,4′-biphenyl tetracarboxylic dianhydate, bis(phthalic acid)phenylphosphine oxide dianhydride, p-phenylene-bis(triphenylphthalic acid)dianhydride, m-phenylene-bis(triphenylphthalic acid)dianhydride, bis(tniphenylphthalic acid)-4,4′-diphenylether dianhydride, bis(triphenylphthalic acid)-4,4′-diphenylether dianhydride, bis(triphenylphthalic acid)-4,4′-diphenylmethane dianhydride, ethylene glycol-bis(anhydrotrimelitate), propylene glycol-bis(anhydrotrimelitate), 1,4-butanediol-bis(anhydrotrimelitate), 1,6-hexyanediol-bis(anhydrotrimelitate), 1,8-octanediol-bis(anhydrotrimelitate), 2,2-bis(4-hydroxyphenyl)propane-bis(anhydrotrimelitate), 2,3,4,5-tetrahydrofurantetracarboxylic dianhydride, 1,3,3a,4,5,9b-Hexahydro-5-(tetrahydro-2,5-dioxofuran-3-yl)naphtho[1,2-c]furan-1,3-dione, 1,3,3a,4,5,9b-Hexahydro-5-methyl-5-(tetrahydro-2,5-dioxofuran-3-yl)naphtho[1,2-c]furan-1,3-dione, 1,3,3a,4,5,9b-Hexahydro-5-ethyl-5-(tetrahydro-2,5-dioxofuran-3-yl)naphtho[1,2-c]furan-1,3-dione, 1,3,3a,4,5,9b-Hexahydro-7-methyl-5-(tetrahydro-2,5-dioxofuran-3-yl)naphtho[1,2-c]furan-1,3-dione, 1,3,3a,4,5,9b-Hexahydro-7-ethyl-5-(tetrahydro-2,5-dioxofuran-3-yl)naphtho[1,2-c]furan-1,3-dione, 1,3,3a,4,5,9b-Hexahydro-8-methyl-5-(tetrahydro-2,5-dioxofuran-3-yl)naphtho[1,2-c]furan-1,3-dione, 1,3,3a,4,5,9b-Hexahydro-8-ethyl-5-(tetrahydro-2,5-dioxofuran-3-yl)naphtho[1,2-c]furan-1,3-dione, 1,3,3a,4,5,9b-Hexahydro-5-(tetrahydro-2,5-dioxofuran-3-yl)naphtho[1,2-c]furan-1,3-dione, 1,3,3a,4,5,9b-Hexahydro-5,8-dimethyl-5-(tetrahydro-2,5-dioxofuran-3-yl)naphtho[1,2-c]furan-1,3-dione, 5-(2,5-dioxotetrahydrofuran)-3-methyl-3-cyclohexene-1,2-dicarboxylic dianhydride and the like.

The tetracarboxylic dianhydride component (a) having a structure of formula (V-1) to (V-6) all of which are showed as follows:

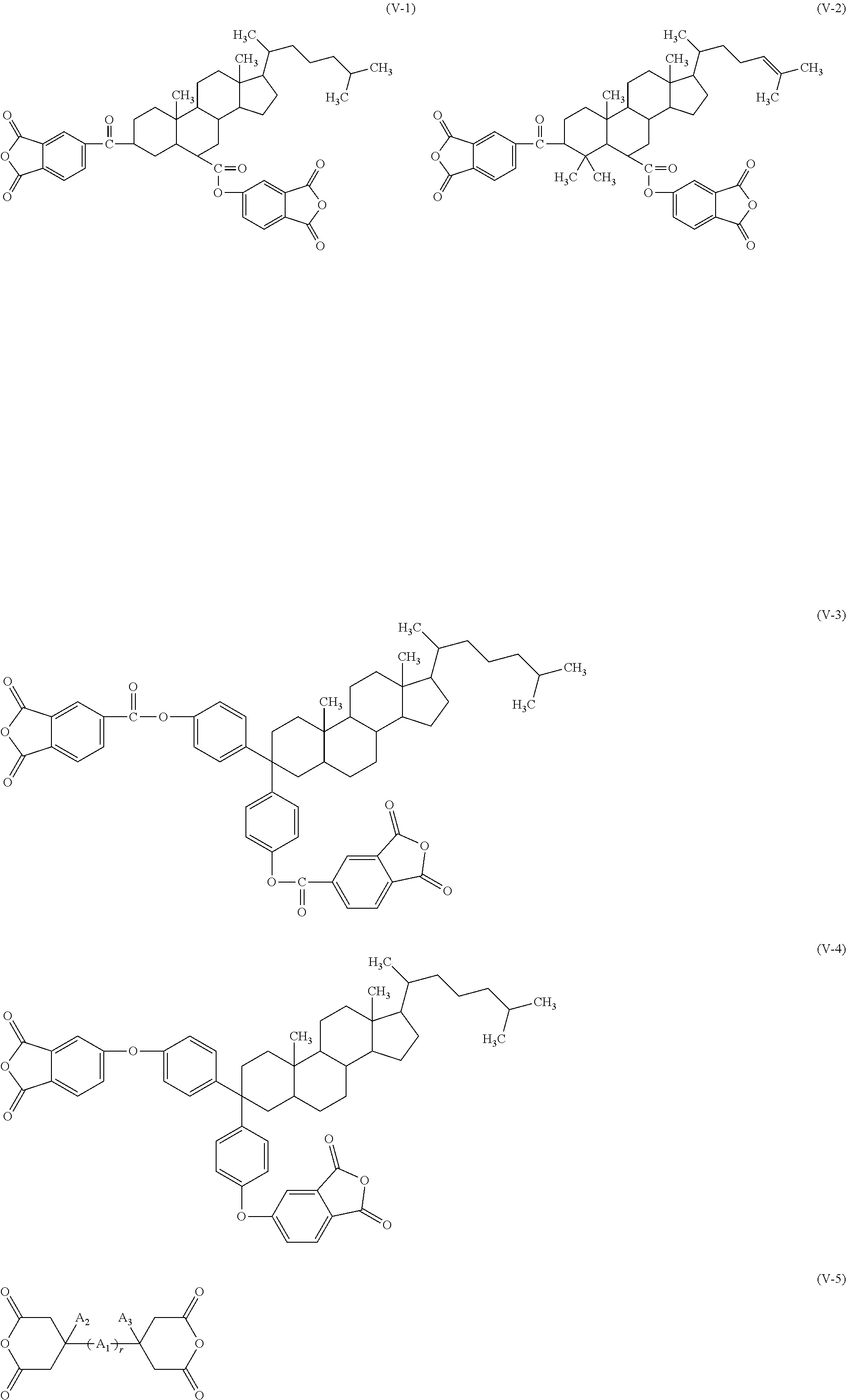

In formula (V-5), A₁ is a divalent group having an aromatic group; r is an integer of 1 or 2; A₂ and A₃ can be the same or different, and A₂ and A₃ respectively are a hydrogen atom or alkyl. Preferably, the tetracarboxylic dianhydride component (a) having a structure of formula (V-5) can be selected from the group consisting of a compound having a structure of formula (V-5-1) to (V-5-3):

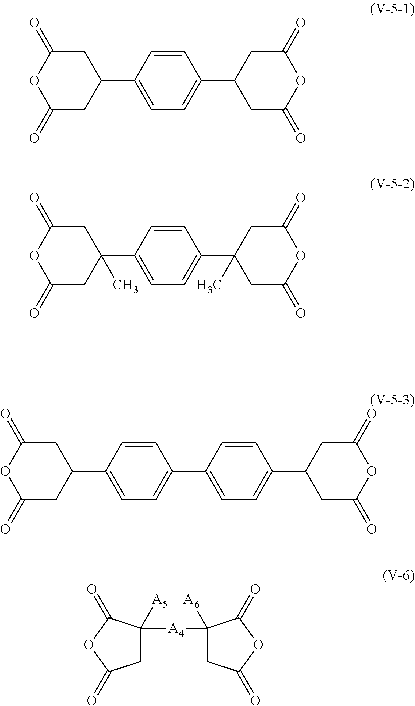

In formula (V-6), A₄ is a divalent group having an aromatic group; A₅ and A₆ can be the same or different, and A₅ and A₆ respectively are a hydrogen atom or alkyl. Preferably, the tetracarboxylic dianhydride component (a) having a structure of formula (V-6) can be selected from the group consisting of the compound having a structure of formula (V-6-1):

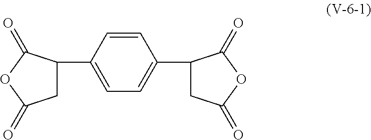 [SMILES: O=C1CC(c2ccc(C3CC(=O)OC3=O)cc2)C(=O)O1]

Preferably, the tetracarboxylic dianhydride component (a) includes but is not limited 1,2,3,4-cyclobutane tetracarboxylic dianhydride, 1,2,3,4-cyclopentane tetracarboxylic dianhydride, 2,3,5-tricarboxycyclopentane acetic acid dianhydride, 1,2,4,5-cyclohexane tetracarboxylic dianhydride, 3,4-dicarboxy-1,2,3,4-tetrahydronaphthalene-1-succinic acid dianhydride, pyromellitic dianhydride, 3,3′,4,4′-benzophenone tetracarboxylic dianhydride and 3,3′,4,4′-biphenylsulfone tetracarboxylic dianhydride. The aforementioned tetracarboxylic dianhydride component (a) can be used alone or a combination two or more.

### Diamine Component (b)

The diamine component (b) includes at least one diamine compound (b-1) having a structure of formula (I), at least one diamine compound (b-2) selected from a group consisting of a compound having a structure of formula (II) and (III) and the other diamine compound (b-3).

Diamine Compound (b-1)

The diamine compound (b-1) has a structure of formula (I):

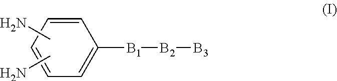

in the formula (I), B₁ is an alkylene group of 1 to 6 carbons; B2 is

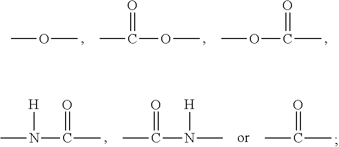

B₃ is an alkyl group of 1 to 6 carbons, an alkoxy group of 1 to 6 carbons, an alkenyl group of 1 to 6 carbons, an aryl group of 6 to 20 carbons or an aralkyl group of 7 to 20 carbons.

For example, the diamine compound (b-1) is 2,4-diaminophenylacetic acid methyl ester, 3,5-diaminophenylacetic acid methyl ester, 2,4-diaminophenylacetic acid ethyl ester, 3,5-diaminophenylacetic acid ethyl ester, 2,4-diaminophenylacetic acid propyl ester, 3,5-diaminophenylacetic acid propyl ester, 2,4-diaminophenylacetic acid butyl ester, 3,5-diaminophenylacetic acid butyl ester, 2,4-diaminophenylpropanoic acid ethyl ester, 3,5-diaminophenylpropanoic acid ethyl ester, 1,3-diamino-4-(2-methoxymethyl) benzene, 1,3-diamino-4-(2-ethoxymethyl)benzene, 1,3-diamino-4-(2-propoxymethyl)benzene, 1,3-diamino-4-(2-butoxymethyl)benzene, 1,3-diamino-4-(2-methoxyethyl)benzene, 1,3-diamino-4-(2-ethoxyethyl)benzene, 1,3-diamino-4-(2-propoxyethyl)benzene, 1,3-diamino-4-(2-butoxyethyl)benzene, 1,3-diamino-5-(2-methoxymethyl)benzene, 1,3-diamino-5-(2-ethoxymethyl)benzene, 1,3-diamino-5-(2-propoxymethyl)benzene, 1,3-diamino-5-(2-butoxymethyl)benzene, 1,3-diamino-5-(2-methoxyethyl)benzene, 1,3-diamino-5-(2-ethoxyethyl)benzene, 1,3-diamino-5-(2-propoxyethyl)benzene, 1,3-diamino-5-(2-butoxyethyl)benzene and the like.

Based on the diamine component (b) as 100 moles, the amount of the diamine compound (b-1) is 5 moles to 50 moles, preferably is 10 moles to 45 moles, and more preferably is 15 moles to 40 moles.

Diamine Compound (b-2)

The diamine compound (b-2) has a structure of formula (II):

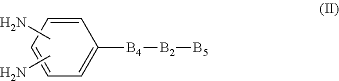

in the formula (II), B₂ is the same as above; B₄ is an alkylene group, a haloalkylene group of 1 to 12 carbons; B₅ is a steroid-containing group, a structure of formula (II-1) or —B₅₁—B₂—B₅₂. B₅₁ is an alkylene group of 1 to 10 carbons, and B₅₂ is a steroid-containing group or has a structure of formula (II-1):

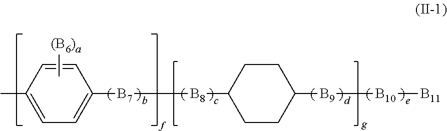

in the formula (II-1), B₆ is a hydrogen atom, a fluoro atom or a methyl group; B₇, B₈ and B₉ respectively are a single bond,

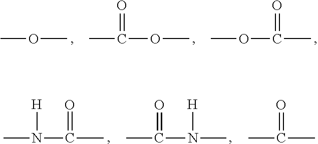

or an alkylene group of 1 to 3 carbons; B₁₀ is

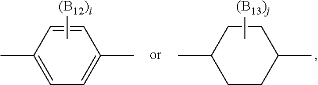

B₁₂ and B₁₃ respectively are a hydrogen atom, a fluoro atom or a methyl group; B₁₁ is a hydrogen atom, a fluoro atom, an alkyl group of 1 to 12 carbons, a fluoroalkyl group of 1 to 12, an alkoxyl group of 1 to 12 carbons, —OCH₂F, —OCHF₂ or —OCF₃; a is 1 or 2; b, c and d respectively are an integer of 0 to 4; e, f and g respectively are an integer of 0 to 3, and e+f+g≧1; i and j respectively are 1 or 2; when B₆, B₇, B₈, B₉, B₁₀, B₁₁, B₁₂ or B₁₃ are pluralities, B₆, B₇, B₈, B₉, B₁₀, B₁₁, B₁₂ or B₁₃ respectively are the same or different.

For example, the diamine compound (b-2) having a structure of formula (II) is 1-cholesteryloxymethyl-2,4-diaminobenzene, 2-cholesteryloxyethyl-2,4-diaminobenzene, 3-cholesteryloxypropyl-2,4-diaminobenzene, 4-cholesteryloxybutyl-2,4-diaminobenzene, 1-cholesteryloxymethyl-3,5-diaminobenzene, 2-cholesteryloxyethyl-3,5-diaminobenzene, 3-cholesteryloxypropyl-3,5-diaminobenzene, 4-cholesteryloxybutyl-3,5-diaminobenzene, 1-(1-cholesteryloxy-1,1-difluoromethyl)-2,4-diaminobenzene, 1-(2-cholesteryloxy-1,1,2,2-tetrafluoroethyl)-2,4-diaminobenzene, 1-(3-cholesteryloxy-1,1,2,2,3,3-hexafluoropropyl)-2,4-diaminobenzene, 1-(4-cholesteryloxy-1,1,2,2,3,3,4,4-octafluorobutyl)-2,4-diaminobenzene, 1-(1-cholesteryloxy-1,1-difluoromethyl)-3,5-diaminobenzene, 1-(2-cholesteryloxy-1,1,2,2-tetrafluoroethyl)-3,5-diaminobenzene, 1-(3-cholesteryloxy-1,1,2,2,3,3-hexafluoropropyl)-3,5-diaminobenzene, 1-(4-cholesteryloxy-1,1,2,2,3,3,4,4-octafluorobutyl)-3,5-diaminobenzene, 1-cholestanyloxymethyl-2,4-diaminobenzene, 2-cholestanyloxyethyl-2,4-diaminobenzene, 3-cholestanyloxypropyl-2,4-diaminobenzene, 4-cholestanyloxybutyl-2,4-diaminobenzene, 1-cholestanyloxymethyl-3,5-diaminobenzene, 2-cholestanyloxyethyl-3,5-diaminobenzene, 3-cholestanyloxypropyl-3,5-diaminobenzene, 4-cholestanyloxybutyl-3,5-diaminobenzene, 1-(1-cholestanyloxy-1,1-difluoromethyl)-2,4-diaminobenzene, 1-(2-cholestanyloxy-1,1,2,2-tetrafluoroethyl)-2,4-diaminobenzene, 1-(3-cholestanyloxy-1,1,2,2,3,3-hexafluoropropyl)-2,4-diaminobenzene, 1-(4-cholestanyloxy-1,1,2,2,3,3,4,4-octafluoropropyl)-2,4-diaminobenzene, 1-(1-cholestanyloxy-1,1-difluoromethyl)-3,5-diaminobenzene, 1-(2-cholestanyloxy-1,1,2,2-tetrafluoroethyl)-3,5-diaminobenzene, 1-(3-cholestanyloxy-1,1,2,2,3,3-hexafluoropropyl)-3,5-diaminobenzene, 1-(4-cholestanyloxy-1,1,2,2,3,3,4,4-octafluoropropyl)-3,5-diaminobenzene, 3-(2,4-diaminophenylmethoxy)-4,4-dimethylcholestane, 3-[2-(2,4-diaminophenyl)ethoxy]-4,4-dimethylcholestane, 3-[3-(2,4-diaminophenyl) propoxy]-4,4-dimethylcholestane, 3-[4-(2,4-diaminophenyl)butoxy]-4,4-dimethylcholestane, 3-(3,5-diaminophenylmethoxy)-4,4-dimethylcholestane, 3-[2-(3,5-diaminophenyl)ethoxy]-4,4-dimethylcholestane, 3-[3-(3,5-diaminophenyl)propoxy]-4,4-dimethylcholestane, 3-[4-(3,5-diaminophenyl)butoxy]-4,4-dimethylcholestane, 3-[1-(2,4-diaminophenyl)-1,1-difluoromethoxy]-4,4-dimethylcholestane, 3-[2-(2,4-diaminophenyl)-1,1,2,2-tetrafluoromethoxy]-4,4-dimethylcholestane, 3-[3-(2,4-diaminophenyl)-1,1,2,2,3,3-hexafluoromethoxy]-4,4-dimethylcholestane, 3-[4-(2,4-diaminophenyl)-1,1,2,2,3,3,4,4-octafluoromethoxy]-4,4-dimethylcholestane, 3-[1-(3,5-diaminophenyl)-1,1-difluoromethoxy]-4,4-dimethylcholestane, 3-[2-(3,5-diaminophenyl)-1,1,2,2-tetrafluoromethoxy]-4,4-dimethylcholestane, 3-[3-(3,5-diaminophenyl)-1,1,2,2,3,3-hexafluoromethoxy]-4,4-dimethylcholestane, 3-[4-(3,5-diaminophenyl)-1,1,2,2,3,3,4,4-octafluoromethoxy]-4,4-dimethylcholestane, 3-(2,4-diaminophenyl)methoxycholane-24-oic hexadecyl ester, 3-[2-(2,4-diaminophenyl)ethoxy]cholane-24-oic hexadecyl ester, 3-[3-(2,4-diaminophenyl)propoxy]cholane-24-oic hexadecyl ester, 3-[4-(2,4-diaminophenyl)butoxy]cholane-24-oic hexadecyl ester, 3-(3,5-diaminophenyl)methoxycholane-24-oic hexadecyl ester, 3-[2-(3,5-diaminophenyl)ethoxy]cholane-24-oic hexadecyl ester, 3-[3-(3,5-diaminophenyl)propoxy]cholane-24-oic hexadecyl ester, 3-[4-(3,5-diaminophenyl)butoxy]cholane-24-oic hexadecyl ester, 3-[1-(3,5-diaminophenyl)-1,1-difluoromethoxy]cholane-24-oic hexadecyl ester, 3-[2-(3,5-diaminophenyl)-1,1,2,2-tetrafluoromethoxy]cholane-24-oic hexadecyl ester, 3-[3-(3,5-diaminophenyl)-1,1,2,2,3,3-hexafluoropropoxy]cholane-24-oic hexadecyl ester, 3-[4-(3,5-diaminophenyl)-1,1,2,2,3,3,4,4-octafluoropropoxy]cholane-24-oic hexadecyl ester.

3-(3,5-diaminophenyl)methoxycholane-24-oic stearyl ester, 3-[2-(3,5-diaminophenyl)ethoxy]cholane-24-oic stearyl ester, 3-[3-(3,5-diaminophenyl)propoxy]cholane-24-oic stearyl ester, 3-[4-(3,5-diaminophenyl)butoxy]cholane-24-oic stearyl ester, 3-[1-(3,5-diaminophenyl)-1,1-difluoromethoxy]cholane-24-oic stearyl ester, 3-[2-(3,5-diaminophenyl)-1,1,2,2-tetrafluoromethoxy]cholane-24-oic stearyl ester, 3-[3-(3,5-diaminophenyl)-1,1,2,2,3,3-hexafluoropropoxy]cholane-24-oic stearyl ester, 3-[4-(3,5-diaminophenyl)-1,1,2,2,3,3,4,4-octafluoropropoxy]cholane-24-oic stearyl ester or the diamine compound (b-2) having a structure of formula (II-2) to (II-18):

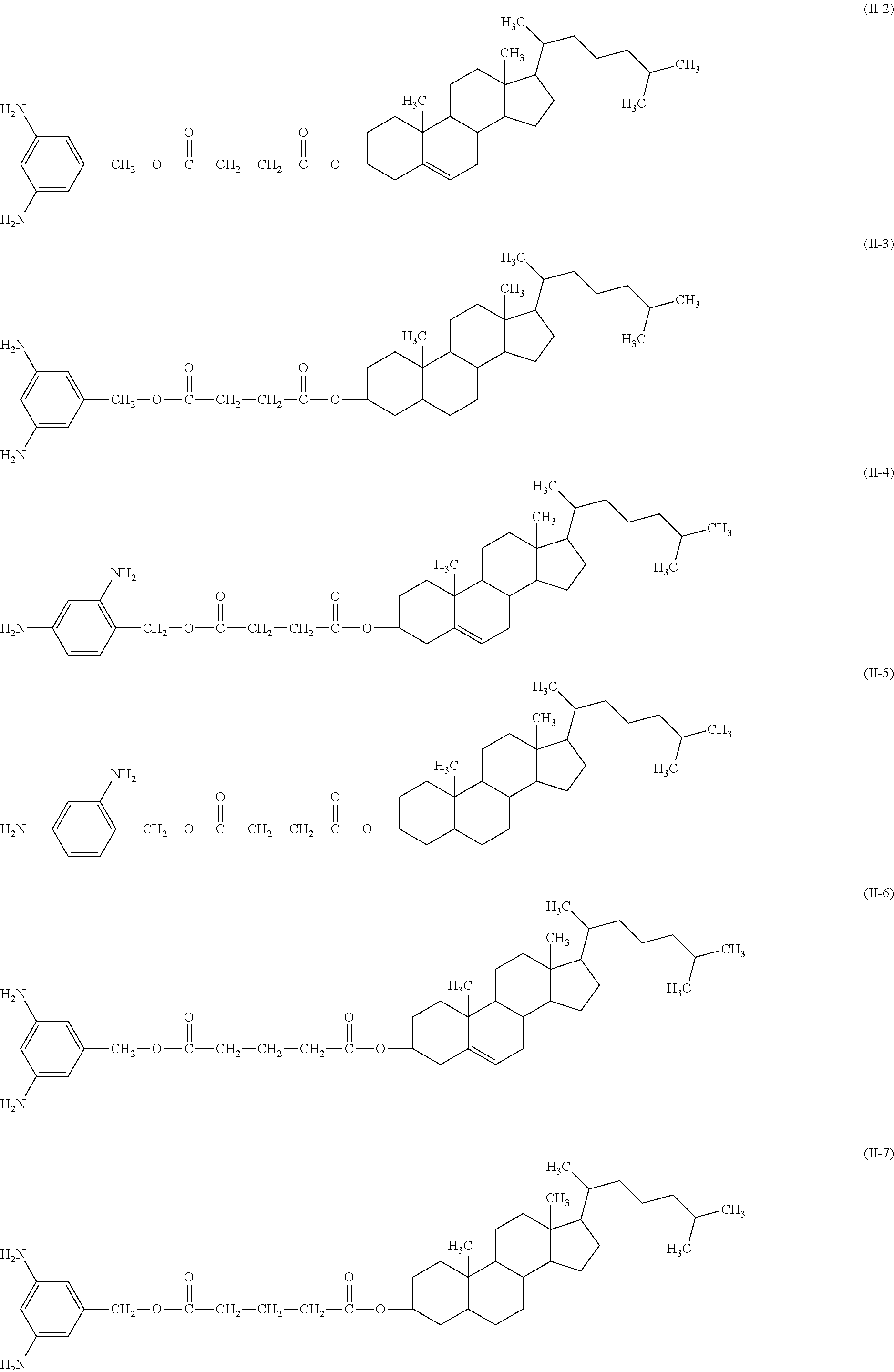 [SMILES: CC(C)CCCC(C)C1CCC2C3CC=C4CC(OC(=O)CCC(=O)OCc5cc(N)cc(N)c5)CCC4(C)C3CCC12C ; CC(C)CCCC(C)C1CCC2C3CCC4CC(OC(=O)CCC(=O)OCc5cc(N)cc(N)c5)CCC4(C)C3CCC12C ; CC(C)CCCC(C)C1CCC2C3CC=C4CC(OC(=O)CCC(=O)OCc5ccc(N)cc5N)CCC4(C)C3CCC12C ; CC(C)CCCC(C)C1CCC2C3CCC4CC(OC(=O)CCC(=O)OCc5ccc(N)cc5N)CCC4(C)C3CCC12C ; CC(C)CCCC(C)C1CCC2C3CC=C4CC(OC(=O)CCCC(=O)OCc5cc(N)cc(N)c5)CCC4(C)C3CCC12C ; CC(C)CCCC(C)C1CCC2C3CCC4CC(OC(=O)CCCC(=O)OCc5cc(N)cc(N)c5)CCC4(C)C3CCC12C]

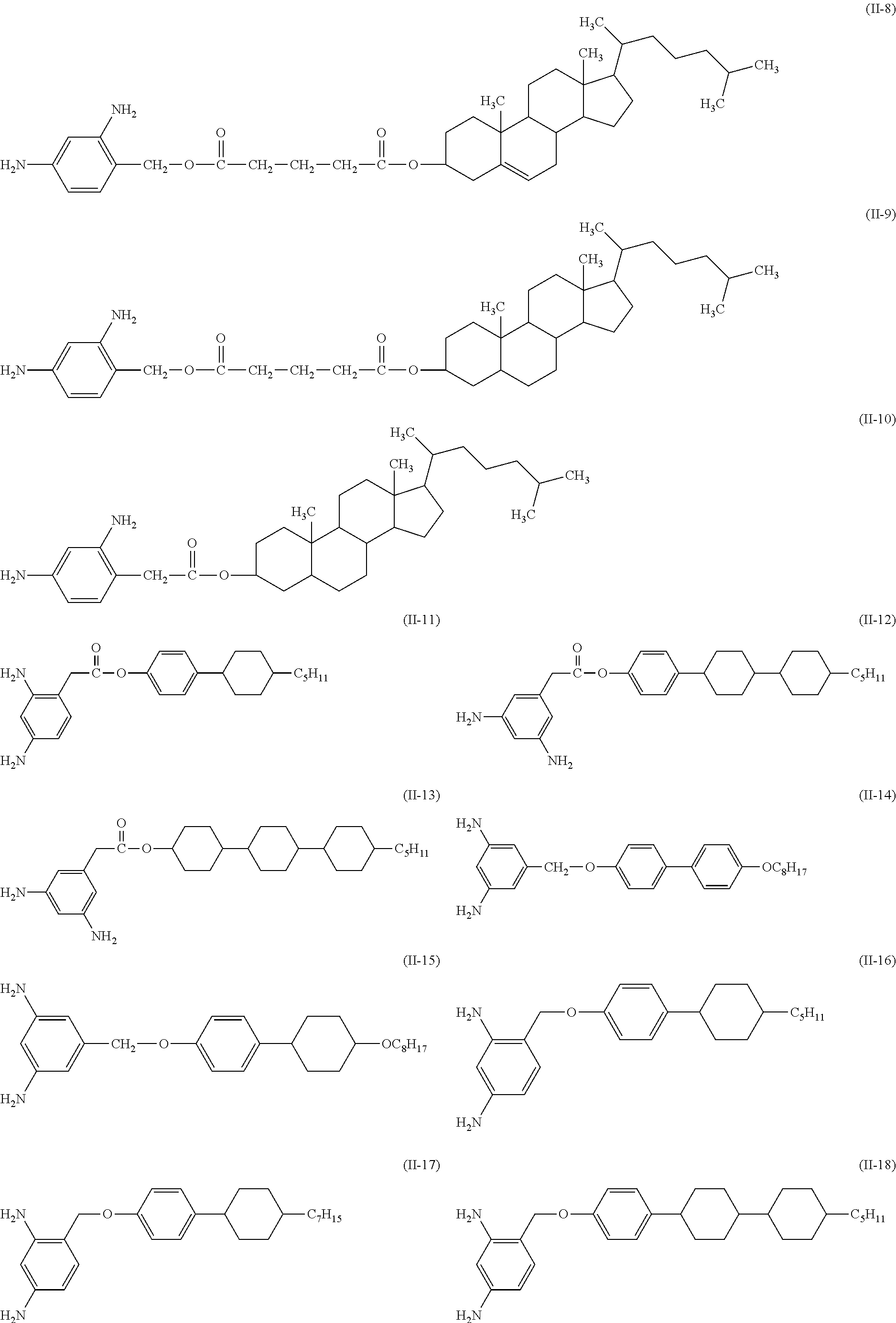

Preferably, the aforementioned diamine compound (b-2) is 1-cholesteryloxymethyl-2,4-diamino benzene, 2-cholesteryloxyethyl-2,4-diamino benzene, 1-cholesteryloxymethyl-3,5-diamino benzene, 2-cholesteryloxyethyl-3,5-diamino benzene, 1-cholesteryloxymethyl-2,4-diamino benzene, 1-cholestanyloxymethyl-2,4-diamino benzene, 2-cholestanyloxyethyl-2,4-diamino benzene, 1-cholestanyloxymethyl-3,5-diamino benzene, 2-cholestanyloxyethyl-3,5-diamino benzene or the diamine compound (b-2) having a structure of aforementioned formula (II-2), (II-3), (II-10), (II-11), (II-12), (II-16) or (II-17).

The aforementioned diamine compound (b-2) having a structure of formula (II) can be used alone or a combination thereof.

The diamine compound (b-2) of the present invention also has a structure of formula (II):

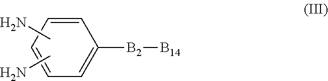

in the formula (III), B₂ is the same as above, and B₁₄ has a structure of formula (III-1):

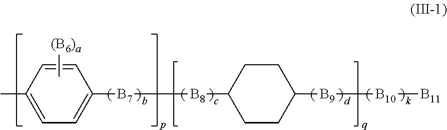

in the formula (III-1), B₆, B₇, B₈, B₉, B₁₀ and B₁₁ respectively are the same as the aforementioned groups; a, b, c and d respectively are the same as the aforementioned numerical values; k, p and q respectively are an integer of 0 to 3, and k+p+q≧3.

For example, the diamine compound (b-2) having a structure of formula (III) is shown as a structure of formula (III-2) to (III-9):

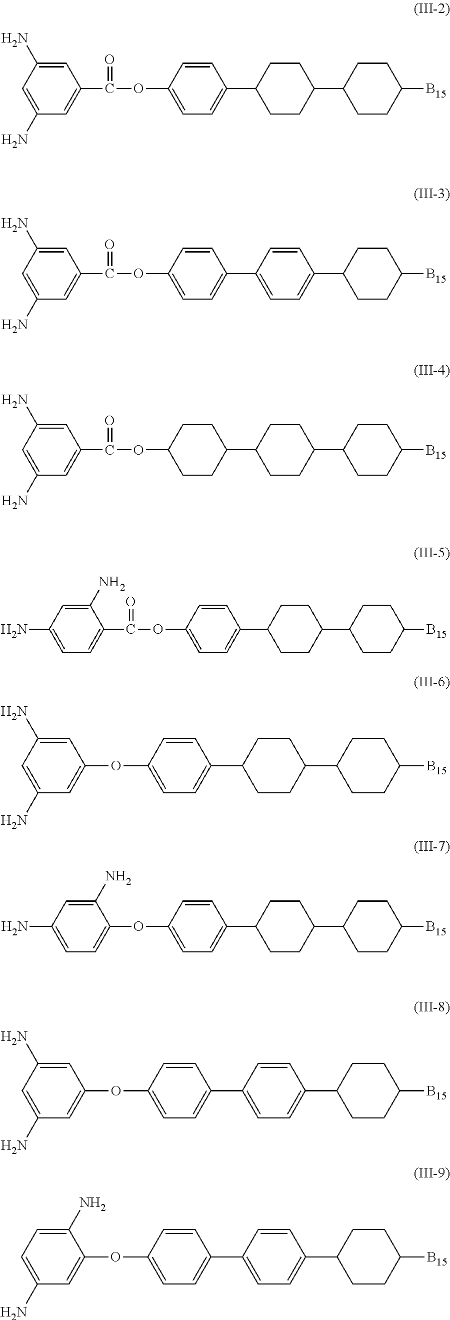

in the formula (III-2) to (III-9), B₁₅ preferably is a hydrogen atom, an alkyl group of 1 to 10 carbons or an alkoxyl group of 1 to 10 carbons.

Preferably, the diamine compound (b-2) having a structure of formula (III) is the diamine compound having a structure of formula (III-10) to (III-14):

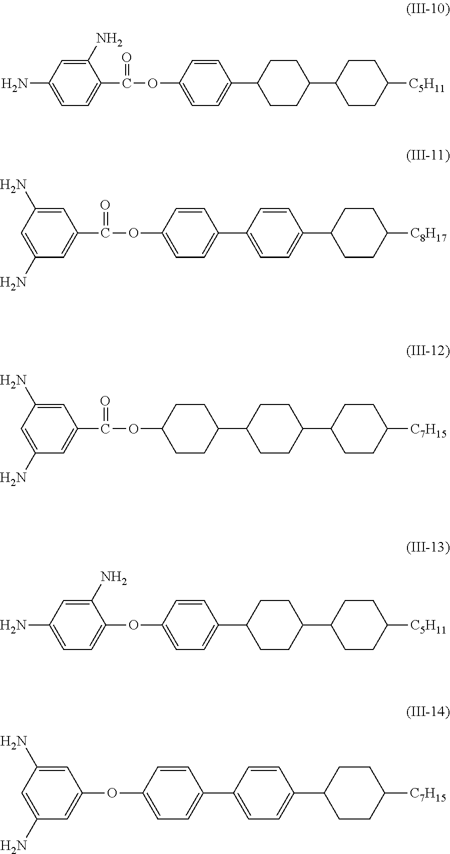

The aforementioned diamine compound (b-2) can used alone or a combination thereof.

Based on the diamine component (b) as 100 moles, the amount of the diamine compound (b-2) is 15 moles to 50 moles, preferably is 18 moles to 45 moles, and more preferably is 20 moles to 40 moles.

In the liquid crystal alignment agent of the present invention, when the diamine component (b) includes the diamine compound (b-1) and the diamine compound (b-2), the liquid crystal alignment agent has a better long-term printability.

A molar ratio of the diamine compound (b-1) and the diamine compound (b-2) is 0.15 to 3.0, preferably is 0.18 to 2.8, and more preferably is 0.2 to 2.5. When the molar ratio [(b-1)/(b-2)] of the diamine compound (b-1) and the diamine compound (b-2) is 0.15 to 3.0, the diamine component (b) can further improve the long-term printability of the liquid crystal alignment agent.

Other Diamine Compound (b-3)

The other diamine compound (b-3) includes but is not limited 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 4,4′-diaminoheptane, 1,3-diamino-2,2-dimethylpropane, 1,6-diamino-2,5-dimethylhexane, 1,7-diamino-2,5-dimethylheptane, 1,7-diamino-4,4-dimethylheptane, 1,7-diamino-3-methylheptane, 1,9-diamino-5-methylnonane, 2,11-diaminododecane, 1,12-diaminooctadecane, 1,2-bis(3-aminopropoxyl)ethane, 4,4′-diaminodicyclohexylmethane, 4,4′-diamino-3,3′-dimethyldicyclohexylamine, 1,3-diaminocyclohexane, 1,4-diaminocyclohexane, isophoronediamine, tetrahydrodicyclopentadiene diamine, tricyclo(6.2.1.0^{2,7})-undecenoyl dimethyldiamine, 4,4′-methylenebis(cyclohexylamine), 4,4′-diaminodiphenylmethane, 4,4′-diaminodiphenylethane, 4,4′-diaminodiphenylsulfone, 4,4′-diaminobenzanilide, 4,4′-diaminodiphenylether, 3,4′-diaminodiphenylether, 1,5-diaminonaphthalene, 5-amino-1-(4′-aminophenyl)-1,3,3-trimethylindane, 6-amino-1-(4-aminophenyl)-1,3,3-trimethylindane, hexahydro-4,7-methanoindanylenedimethylenediamine, 3,3′-diaminobenzophenone, 3,4′-diaminobenzophenone, 4,4′-diaminobenzophenone, 2,2-bis[4-(4-aminophenoxy)phenyl]propane, 2,2-bis[4-(4-aminophenoxy)phenyl]hexafluoropropane, 2,2-bis(4-aminophenyl)hexafluoropropane, 2,2-bis[4-(4-aminophenoxy)phenyl]sulfone, 1,4-bis(4-aminophenoxyl)benzene, 1,3-bis(4-aminophenoxy)benzene, 1,3-bis(3-aminophenoxyl)benzene, 9,9-bis(4-aminophenyl)-10-hydroanthracene, 9,10-bis(4-aminophenyl)anthracene, 2,7-diaminofluorene, 9,9-bis(4-aminophenyl)fluorene, 4,4′-methylene-bis(2-chloroaniline), 4,4′-(p-phenyleneisopropylene)bisaniline, 4,4′-(m-phenylene isopropylene)bisaniline, 2,2′-bis[4-(4-amino-2-trifluoromethyl phenoxy)phenyl]hexafluoropropane, 4,4′-bis[(4-amino-2-trifluoro)phenoxy]octafluorophenyl benzene, 5-[4-(4-n-pentylcyclohexyl)cyclohexyl]phenylmethylene-1,3-diaminobenzene, 1,1-bis[4-(4-aminophenoxy)phenyl]-4-(4-ethylphenyl)cyclohexane, and the other diamine compound (b-3) having a structure of formula (VI-1) to (VI-25):

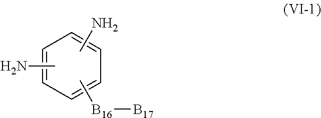

In the formula (VI-1), B₁₆ is

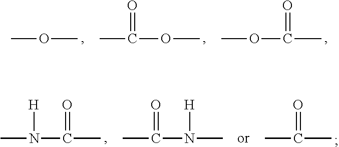

B₁₇ is a steroid-containing group, a trifluoro methyl group, a fluoro group, an alkyl group of 2 to 30 carbons or an monovalent nitrogen-containing cyclic group derived from pyridine, pyrimidine, triazine, piperidine, piperazine and the like.

Preferably, the diamine compound having a structure of formula (VI-1) is 2,4-diaminophenyl ethyl formate, 3,5-diaminophenyl ethyl formate, 2,4-diaminophenyl propyl formate, 3,5-diaminophenyl propyl formate, 1-dodecoxy-2,4-aminobenzene, 1-hexadecoxy-2,4-aminobenzene, 1-octadecoxy-2,4-aminobenzene or the diamine compound (b-3) having a structure of formula (VI-1-1) to (VI-1-4):

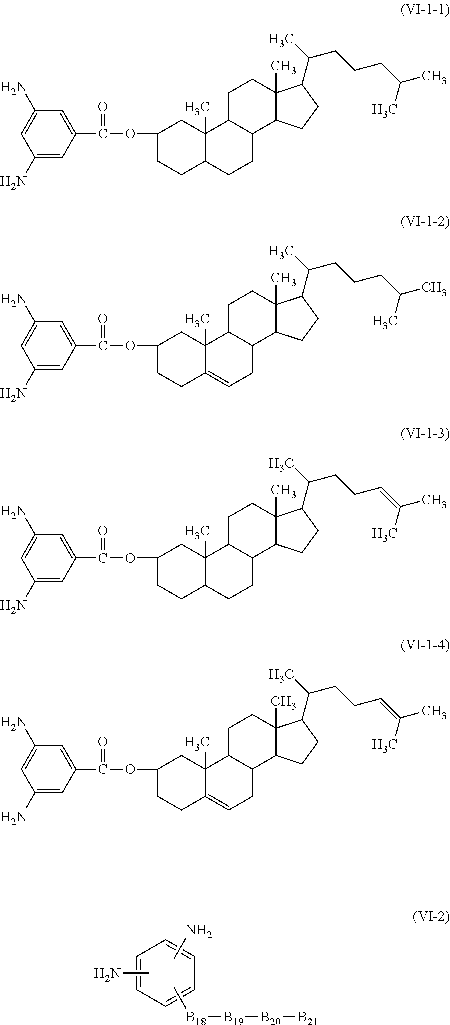

in the formula (VI-2), B₁₈ is

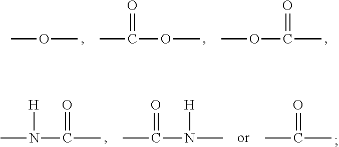

B₁₉ and B₂₀ is an alicyclic group, an aromatic group or a heterocyclic group; B₂₁ is an alkyl group of 3 to 18 carbons, an alkoxyl group of 3 to 18 carbons, a fluoroalkyl group of 1 to 5 carbons, a fluoroalkoxyl group of 1 to 5 carbons, a cyano group or a halogen atom.

Preferably, the other diamine compound (b-3) having a structure of formula (VI-2) is the diamine compound having a structure of formula (VI-2-1) to (VI-2-13):

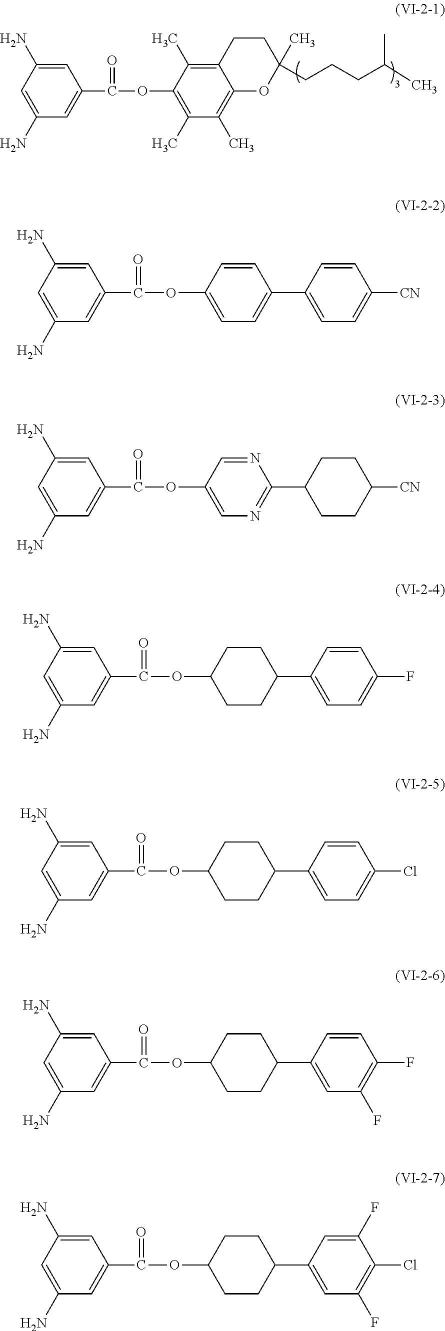

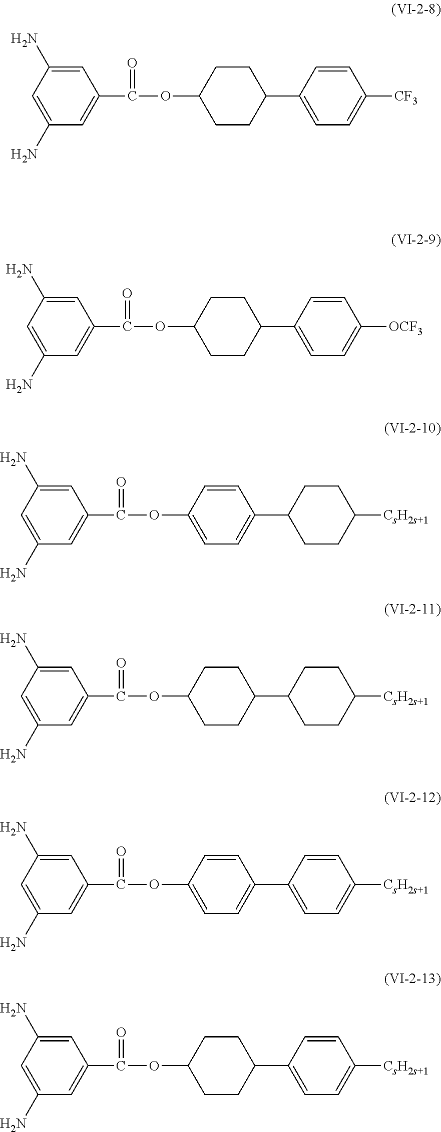

in the formula (VI-2-10) to (VI-2-13), s is an integer of 3 to 12.

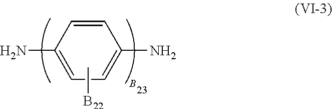

in the formula (VI-3), B₂₂ is a hydrogen atom, an acyl group of 1 to 5 carbons, an alkyl group of 1 to 5 carbons, an alkoxyl group of 1 to 5 carbons, or a halogen atom. In every repeating unit, B₂₂ can be the same or different; B₂₃ is an integer of 1 to 3.

The diamine compound having a structure of formula (VI-3) preferably is selected from the group consisting of (1) when B₂₃ is 1, such as p-diaminobenzene, m-diaminobenzene, o-diaminobenzene, 2,5-diaminotoluene and the like; (2) when B₂₃ is 2, such as 4,4′-diaminobiphenyl, 2,2′-dimethyl-4,4′-diaminobiphenyl, 3,3′-dimethyl-4,4′-diaminobiphenyl, 3,3′-dimethoxy-4,4′-diaminobiphenyl, 2,2′-dichloro-4,4′-diaminobiphenyl, 3,3′-dichloro-4,4′-diaminobiphenyl, 2,2′,5,5′-tetrachloro-4,4′-diaminobiphenyl, 2,2′-dichloro-4,4′-diamino-5,5′-dimethoxybiphenyl, 4,4′-diamino-2,2′-bis(trichloromethyl)biphenyl and the like; (3) when B₂₃ is 3, such as 1,4-bis(4′-aminophenyl)benzene and the like, and more preferably is p-diaminobenzene, 2,5-diaminotoluene, 4,4′-diaminobiphenyl, 3,3′-dimethoxy-4,4′-diaminobiphenyl or 1,4-bis(4′-aminophenyl)benzene.

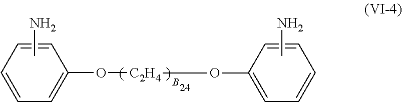

In the formula (VI-4), B₂₄ is an integer of 2 to 12.

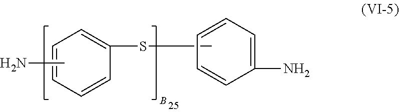

In the formula (VI-5), B₂₅ is an integer of 1 to 5. Preferably, formula (VI-5) is selected from 4,4′-diamino-diphenylsulfide.

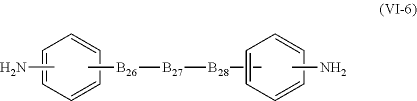

In the formula (VI-6), B₂₆ and B₂₈ can be the same or different, and B₂₆ and B₂₈ respectively are divalent group; B₂₇ is a divalent nitrogen-containing cyclic group derived from pyridine, pyrimidine, triazine, piperidine, piperazine and the like.

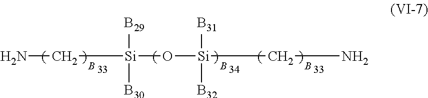

In the formula (VI-7), B₂₉, B₃₀, B₃₁ and B₃₂ respectively can be the same or different, and B₂₉, B₃₀, B₃₁ and B₃₂ respectively are an alkyl group of 1 to 12 carbons. B₃₃ is an integer of 1 to 3, and B₃ is an integer of 1 to 20.

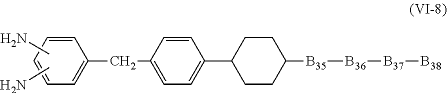

In the formula (VI-8), B₃₅ is —O— or a cyclohexylene; B₃₆ is —CH₂—; B₃₇ is phenylene or cyclohexylene; B₃₈ is a hydrogen atom or a heptyl.

Preferably, the diamine compound having a structure of formula (VI-8) is selected from the group consisting of the diamine compound having a structure of formula (VI-8-1) to (VI-8-2):

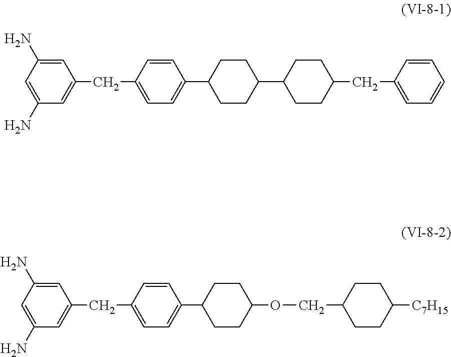

The other diamine compound (b-3) having a structure of formula (VI-9) to (VI-25) are showed as follows:

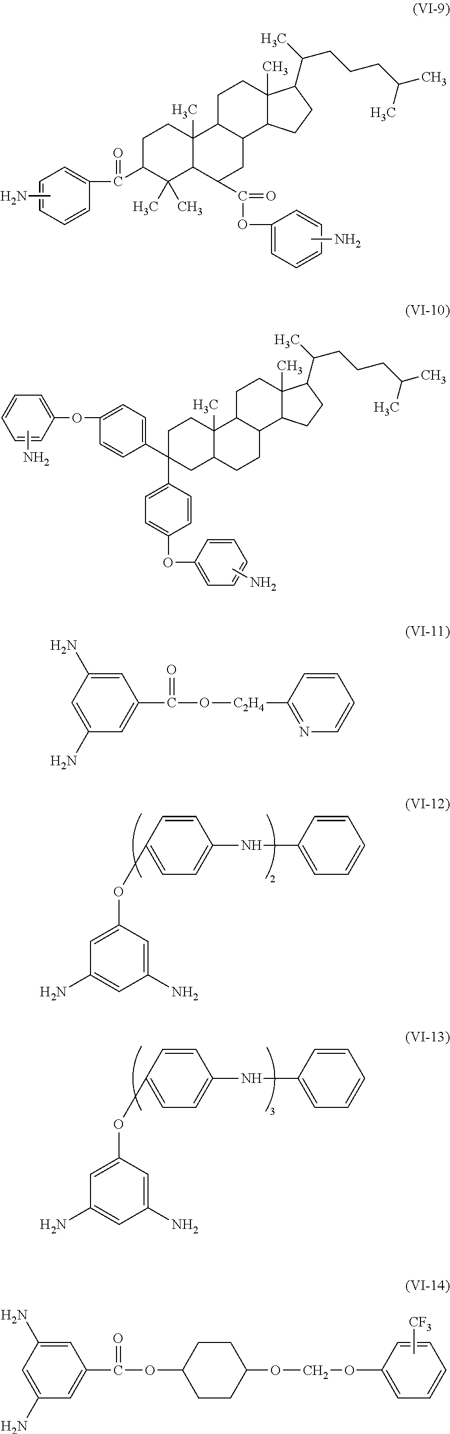

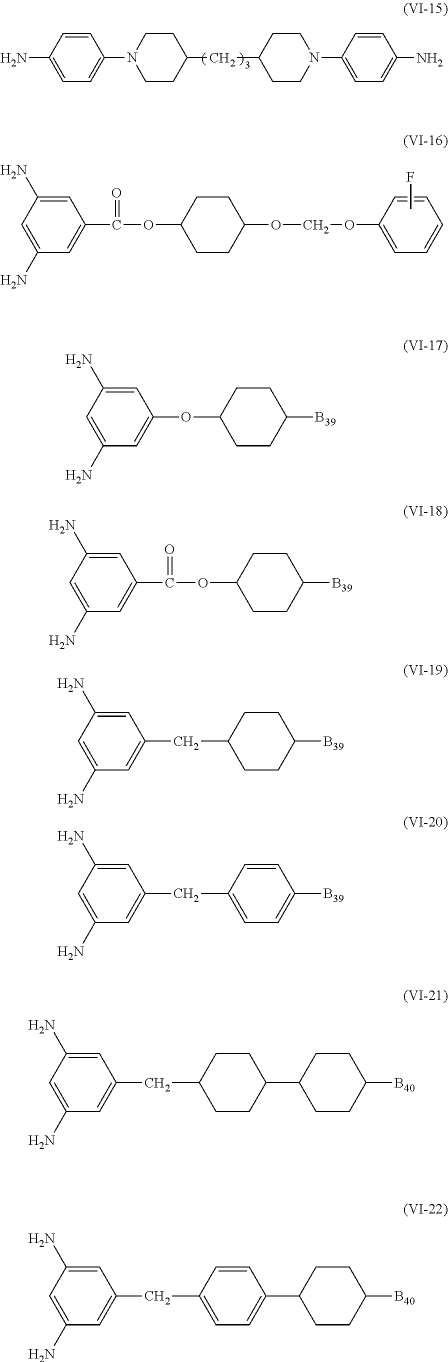

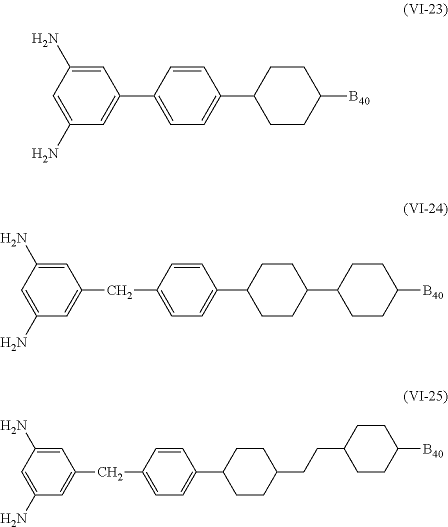

in the formula (VI-17) to (VI-25), B₃₉ preferably is an alkyl group of 1 to 10 carbons, or an alkoxyl group of 1 to 10 carbons; B₄₀ preferably is a hydrogen atom, an alkyl group of 1 to 10 carbons, or an alkoxyl group of 1 to 10 carbons.

Preferably, the other diamine compound (b-3) includes but is not limited 1,2-diaminoethane, 4,4′-diaminodicyclohexylmethane, 4,4′-diaminodiphenyl-methane, 4,4′-diaminodiphenylether, 5-[4-(4-n-amylcyclohexyl)cyclohexyl]phenylmethylene-1,3-diamino benzene, 1,1-bis[4-(4-aminophenoxy)phenyl]-4-(4-ethylphenyl)cyclohexane, 2,4-diaminophenyl ethyl formate, the formula (VI-1-1), the formula (VI-1-2), the formula (VI-2-1), the formula (VI-2-11), p-diaminobenzene, m-diaminobenzene, o-diaminobenzene, or the compound shown in the formula (VI-8-1).

Based on the diamine component (b) as 100 moles, the amount of the aforementioned other diamine compound (b-3) is 1 mole to 80 moles, preferably is 10 moles to 72 moles, and more preferably is 20 moles to 65 moles.

### Method of Producing Polymer Composition (A)

Method of Producing Polyamic Acid

A mixture is dissolved in a solvent, and the mixture includes a tetracarboxylic dianhydride component (a) and a diamine component (b). A polycondensation reaction is performed at 0° C. to 100° C. After 1 hr to 24 hrs, the aforementioned reacting solution is subjected to a reduced pressure distillation by an evaporator, or the aforementioned reacting solution was poured into a great quantity poor solvent to obtain a precipitate. Then, the precipitate is dried by a method of reduced pressure drying to produce polyamic acid.

Based on the diamine component (b) as 100 moles, the amount of the tetracarboxylic dianhydride component (a) preferably is 20 moles to 200 moles, and more preferably is 30 moles to 120 moles.

The solvent used in the polycondensation reaction can be the same as or different from the solvent in the liquid crystal alignment agent. The solvent used in the polycondensation reaction does not have any special limitations. The solvent needs to dissolve the reactant and the product. Preferably, the solvent includes but is not limited (1) aprotic solvent, such as N-methyl-2-pyrrolidinone (NMP), N,N-dimethylacetamide, N,N-dimethyl-formamide, dimethylsulfoxide, γ-butyrolactone, tetramethylurea, hexmethyl phosphoric acid triamino and the like; (2) phenolic solvent, such as m-cresol, xylenol, phenol, halogenated phenol and the like. Based on the mixture as 100 parts by weight, the amount of the solvent used in the polycondensation reaction preferably is 200 to 2000 parts by weight, and more preferably is 300 to 1800 parts by weight.

Particularly, in the polycondensation reaction, the solvent can combine with suitable poor solvent. The formed polyamic acid won't precipitate in the poor solvent. The poor solvent can be used alone or in combination of two or more, and the poor solvent includes but is not limited (1) alcohols, such as methanol, ethanol, isopropanol, cyclohexanol, ethylene glycol, propylene glycol, 1,4-butanediol, triethyleneglycol and the like; (2) ketone, such as acetone, methyl ethyl ketone, methyl isobutyl ketone, cyclohexanone and the like; (3) ester, such as methyl acetate, ethyl acetate, butyl acetate, diethyl oxalate, diethyl malonate, ethylene glycol monoethyl ether acetate and the like; (4) ether, such as diethyl ether, ethylene glycol methyl ether, ethylene glycol ethyl ether, ethylene glycol n-propyl ether, ethylene glycol isopropyl ether, ethylene glycol n-butyl ether, ethylene glycol dimethyl ether, diethylene glycol dimethyl ether and the like; (5) halohydrocarbon, such as dichloromethane, 1,2-dichloroethane, 1,4-dichlorobutane, trichloroethane, chlorobenzene, m-dichlorobenzene and the like; (6) hydrocarbon, such as tetrahydrofuran, hexane, heptane, octane, benzene, toluene, xylene and the like, or a combination thereof. Based on the diamine component (b) as 100 parts by weight, the amount of the poor solvent preferably is 0 to 60 parts by weight, and more preferably is 0 to 50 parts by weight.

Method of Producing Polyimide

A mixture is dissolved in a solvent, and a polymerization reaction is performed to form polyamic acid. The aforementioned mixture includes a tetracarboxylic dianhydride component (a) and a diamine component (b). Then, polyamic acid is heated to subject a dehydration ring-closure reaction in the presence of a dehydrating agent and a catalyst. The amic acid group of the polyamic acid is converted to an imide group by the dehydration ring-closure reaction, that is to say imidization, so as to form polyimide.

The solvent used in the dehydration ring-closure reaction can be the same as the solvent in the liquid crystal alignment agent and is not illustrated any more here. Based on polyamic acid as 100 parts by weight, the amount of the solvent used in the dehydration ring-closure reaction preferably is 200 to 2000 parts by weight, and more preferably is 300 to 1800 parts by weight.

The operating temperature of the dehydration ring-closure reaction preferably is 40° C. to 200° C. for getting a better imidization ratio of the polyamic acid. More preferably, the aforementioned temperature is 40° C. to 150° C. When the operating temperature of the dehydration ring-closure reaction is lower than 40° C., the reaction is incomplete, thereby lowering the imidization ratio of the polyamic acid. However, when the operating temperature is higher than 200° C., the weight-average molecular weight of the polyimide is lower.

The imidization ratio of the polymer composition (A) is 30% to 90%, preferably is 35% to 88%, and more preferably is 40% to 85%. When the imidization ratio of the polymer (A) is 30% to 90%, the produced liquid crystal display element has a high voltage holding ratio.

The dehydrating agent used in the dehydration ring-closure reaction is selected from the group consisting of acid anhydride compound. For example, the acid anhydride compound is acetic anhydride, propionic anhydride, trifluoroacetic anhydride and the like. Based on the polyamic acid as 1 mole, the amount of the dehydrating agent is 0.01 mole to 20 moles. The catalyst used in the dehydration ring-closure reaction is selected from (1) pyridine compound, such as pyridine, trimethylpyridine, dimethylpyridine and the like; (2) tertiary amine compound, such as triethyl amine and the like. Based on the dehydrating agent as 1 mole, the amount of the catalyst is 0.5 mole to 10 moles.

Method of Producing Polyimide Series Block Copolymer

The polyimide series block-copolymer is selected from the group consisting of the polyamic acid block-copolymer, polyimide block-copolymer, polyamic acid-polyimide block copolymer and a combination thereof.

Preferably, a starting material is firstly dissolved in a solvent, and a polycondensation reaction is performed to produce the polyimide series block-copolymer. The starting material includes at least one aforementioned polyamic acid and/or at least one aforementioned polyimide, and the starting material further comprises a tetracarboxylic dianhydride component and diamine component.

The tetracarboxylic dianhydride component (a) and the diamine component (b) in the starting material are the same as the tetracarboxylic dianhydride component (a) and the diamine component (b) used in the method of producing aforementioned polyamic acid. The solvent used in the polycondensation reaction is the same as the solvent in the liquid crystal alignment agent and is not illustrated any more here.

Based on the starting material as 100 parts by weight, the solvent used in the polymerization reaction preferably is 200 to 2000 parts by weight, and more preferably is 300 to 1800 parts by weight. The operating temperature of the polymerization reaction preferably is 0° C. to 200° C., and more preferably is 0° C. to 100° C.

Preferably, the starting material includes but is not limited (1) two polyamic acid having different terminal groups and different structures; (2) two polyimide having different terminal groups and different structures; (3) the polyamic acid and the polyimide that have different terminal groups and different structures; (4) the polyamic acid, the tetracarboxylic dianhydride component and the diamine component, and the structure of the at least one of the tetracarboxylic dianhydride component and the diamine component is different from the structures of the tetracarboxylic dianhydride component and the diamine component that are used to form the polyamic acid; (5) the polyimide, the tetracarboxylic dianhydride component and the diamine component, and the structure of the at least one of the tetracarboxylic dianhydride component and the diamine component is different from the structures of the tetracarboxylic dianhydride component and the diamine component that are used to form the polyimide; (6) the polyamic acid, the polyimide, the tetracarboxylic dianhydride component and the diamine component, and the structure of the at least one of the tetracarboxylic dianhydride component and the diamine component is different from the structures of the tetracarboxylic dianhydride component and the diamine component that are used to form the polyamic acid or the polyimide; (7) two polyamic acid, tetracarboxylic dianhydride components or diamine components, and they have different structures; (8) two polyimide, tetracarboxylic dianhydride components or diamine components, and they have different structures; (9) two polyamic acid and a diamine components, and the two polyamic acid have different structures and the terminal groups of the polyamic acid are acetic anhydride groups; (10) two polyamic acid and a tetracarboxylic dianhydride components, and the two polyamic acid have different structures and the terminal groups of the polyamic acid are amine groups; (11) two polyimide and a diamine components, and the two polyimide have different structures and the terminal groups of the polyimide are acid anhydride groups; (12) two polyimide and a tetracarboxylic dianhydride components, and the two polyimide have different structures and the terminal groups of the polyimide are amine groups.

Preferably, the polyamic acid, the polyimide and the polyimide block copolymer can be terminal-modified polymer after adjusting the molecular weight without departing from the efficiency of the present invention. The terminal-modified polymer can improve a coating ability of the liquid crystal alignment agent. When the polymerization reaction of the polyamic acid is performed, a compound having a monofunctional group is added to produce the terminal-modified polymer. The monofunctional group includes but is not limited (1) monoacid anhydride, such as maleic anhydride, phthalic anhydride, Itaconic anhydride, n-decyl succinic anhydride, n-dodecyl succinic anhydride, n-tetradecyl succinic anhydride, n-hexadecyl succinic anhydride and the like; (2) monoamine compound, such as aniline, cyclohexaylamine, n-butylamine, n-pentylamine, n-hexylamine, n-heptylamine, n-octylamine, n-nonylamine, n-decylamine, n-undecylamine, n-dodecylamine, n-tridecylamine, n-tetradecylamine, n-pentadecylmaine, n-hexadecylamine, n-heptadecylamine, n-octadecylamine, n-eicosylamine and the like; (3) monoisocyanate compound, such as phenyl isocyanate, naphthyl isocyanate and the like.

### Solvent (B)

Preferably, the solvent (B) is N-methyl-2-pyrrolidone, γ-butyrolactone, γ-butyrolactam, 4-hydroxyl-4-methyl-2-pentanone, ethylene glycol monomethyl ether, butyl lactate, butyl acetate, methylmethoxypropionate, ethylethoxypropionate, ethylene glycol methyl ether, ethylene glycol ethyl ether, ethylene glycol n-propyl ether, ethylene glycol isopropyl ether, ethylene glycol n-butyl ether, ethylene glycol dimethyl ether, ethylene glycol ethyl ether acetate, diglycol dimethyl ether, diglycol diethyl ether, diglycol monomethyl ether, diglycol monoethyl ether, diglycol monomethyl ether acetate, diglycol monoethyl ether acetate, N,N-dimethylformamide, N,N-dimethylethanamide and the like. The solvent (B) can be used alone or in combination of two or more.

### Additive (C)

The liquid crystal alignment agent can selectively include an additive (C) without departing from the efficiency of the present invention. The additive (C) is an epoxy compound or a functional group-containing silane compound. The additive (C) can raise the adhesion between the liquid crystal alignment film and the surface of the substrate. The additive (C) can be used alone or in combination of two or more.

The epoxy compound includes but is not limited ethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, 1,6-hexanediol diglycidyl ether, 2,2-dibromo-neopentyl diglycidyl ether, 1,3,5,6-tetraglycidyl-2,4-hexanediol, N,N,N′,N′-tetraglycidyl-m-xylene diamine, 1,3-bis(N,N-diglycidylaminomethyl)cyclohexane, N,N,N′,N′-tetraglycidyl-4,4′-diaminodiphenylmethane, N,N-glycidyl-p-glycidoxy aniline, 3-(N-allyl-N-glycidyl)aminopropyltrimethoxyl silane, 3-(N,N-diglycidyl)aminopropyl trimethoxyl silane and the like.

Based on the polymer composition (A) as 100 parts by weight, the amount of the epoxy compound is less than 40 parts by weight, and preferably is 0.1 parts by weight to 30 parts by weight.

The functional group-containing silane compound includes but is not limited to 3-aminopropyl trimethoxy silane, 3-aminopropyltriethoxysilane, 2-aminopropytrimethoxysilane, 2-aminopropyltriethoxysilane, N-(2-aminoethyl)-3-aminopropyltrimethoxysilane, N-(2-aminoethyl)-3-aminopropylmethyl-dimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-trimethoxysilylpropyltriethylenetriamine, 10-trimethoxysilyl-1,4,7-triazadecane, 10-triethoxysilyl-1,4,7-triazadecane, 9-trimethoxysilyl-3,6-diazanonylacetate, 9-triethoxysilyl-3,6-diazanonylacetate, N-benzyl-3-aminopropyltrimethoxysilane, N-benzyl-3-aminopropyltriethoxysilane, N-phenyl-3-aminopropyltrimethoxy-silane, N-phenyl-3-aminopropyl triethoxysilane, N-bis(oxyethylene)-3-aminopropyltrimethoxysilane, N-bis(oxyethylene)-3-aminopropyltriethoxysilane and the like.

Based on the polymer composition (A) as 100 parts by weight, the amount of the silane-containing compound is less than 10 parts by weight, and preferably is 0.5 parts by weight to 10 parts by weight.

Producing Liquid Crystal Alignment Agent

The liquid crystal alignment agent of the present invention is produced by a conventional mixing method. For example, the tetracarboxylic dianhydride component (a) and the diamine component (b) are mixed uniformly to produce the polymer composition (A). Then, the polymer composition (A) is added to the solvent (B) at 0° C. to 200° C. in a mixer until all compositions are mixed uniformly, and the additive (C) is selectively added. Preferably, the solvent (B) is added into the polymer composition (A) at 20° C. to 60° C.

Preferably, at 25° C., a viscosity of the liquid crystal alignment agent is 15 cps to 35 cps, preferably is 17 cps to 33 cps, and more preferably is 20 cps to 30 cps.

Producing Liquid Crystal Alignment Film

The producing method of the liquid crystal alignment film comprises the following steps. The aforementioned liquid crystal alignment agent firstly is coated on a surface of a substrate to form a coating film by a roller coating, a spin coating, a printing coating, an ink-jet printing and the like. Then, a pre-bake treatment, a post-bake treatment and an alignment treatment are subject to the coating film to produce the liquid crystal alignment film.

An organic solvent in the coating film is volatilized by the aforementioned pre-bake treatment. The operating temperature of the pre-bake treatment is 30° C. to 120° C., preferably is 40° C. to 110° C., and more preferably is 50° C. to 100° C.

The alignment treatment does not have any limitations. The liquid crystal alignment film is rubbed along a desired direction with a roller that is covered with a cloth made from fibers such as nylon, rayon, cotton and the like. The aforementioned alignment treatment is widely known rather than focusing or mentioning them in details.

The polymer in the coating film is further subjected to the dehydration ring-closure (imidization) reaction by the post-bake treatment. The operating temperature of the post-bake treatment is 150° C. to 300° C., preferably is 180° C. to 280° C., and more preferably is 200° C. to 250° C.

Producing Method of Liquid Crystal Display Element

The producing method of the liquid crystal display element is widely known rather than focusing or mentioning them in details.

Reference is made to FIG. 1, which is a cross-sectional diagram of a liquid crystal display element according to the present invention. In a preferable example, the liquid crystal element 100 includes a first unit 110, a second unit 120 and a liquid crystal 130. The second unit 120 is spaced apart opposite the first unit 110, and the liquid crystal 130 is disposed between the first unit 110 and the second unit 120.

The first unit 110 includes a first substrate 111, a first conductive film 113 and a first liquid crystal alignment film 115. The first conductive film 113 is disposed on a surface of the first substrate 111, and the first liquid crystal alignment film 115 is disposed on a surface of the first conductive film 113.

The second unit 120 includes a second substrate 121, a second conductive film 123 and a second liquid crystal alignment film 125. The second conductive film 123 is disposed on a surface of the second substrate 121, and the second liquid crystal alignment film 125 is disposed on a surface of the second conductive film 123.

The first substrate 111 and the second substrate 121 are selected from a transparent material and the like. The transparent material includes but is not limited an alkali-free glass, a soda-lime glass, a hard glass (Pyrex glass), a quartz glass, polyethylene terephthalate, polybutylene terephthalate, polyethersulfone, polycarbonate and the like. The materials of the first conductive film 113 and the second conductive film 123 are selected from tin oxide (SnO₂), indium oxide-tin odide (In₂O₃—SnO₂) and the like.

The first liquid crystal alignment film 115 and the second liquid crystal alignment film 125 respectively are the aforementioned liquid crystal alignment films, which can provide the liquid crystal 130 with a pretilt angle. The liquid crystal 130 is driven by an electric field induced by the first conductive film 113 and the second conductive film 123.

A liquid crystal material used in the liquid crystal 130 can be used alone or in combination of two or more. The liquid crystal material includes but is not limited 1,4-diaminobenzene liquid crystal, pyridazine liquid crystal, Shiff Base liquid crystal, azoxy liquid crystal, biphenyl liquid crystal, phenyl cyclohexane liquid crystal, ester liquid crystal, terphenyl liquid crystal, biphenyl cyclohexane liquid crystal, pyrimidine liquid crystal, dioxane liquid crystal, bicyclooctane liquid crystal, cubane liquid crystal and the like. Optionally, the liquid crystal material includes cholesterol liquid crystal, such as cholesteryl chloride, cholesteryl nonanoate, cholesteryl carbonate and the like, chiral agent, such as products made by Merck Co. Ltd., and the trade name are C-15 and CB-15; ferroelectric liquid crystal, such as p-decoxyl benzilidene-p-amino-2-methyl butyl cinnamate and the like.

Several embodiments are described below to illustrate the application of the present invention. However, these embodiments are not used for limiting the present invention. For those skilled in the art of the present invention, various variations and modifications can be made without departing from the spirit and scope of the present invention.

### BRIEF DESCRIPTION OF THE DRAWINGS

The invention can be more fully understood by reading the following detailed description of the embodiment, with reference made to the accompanying drawings as follows:

FIG. 1 is a cross-sectional diagram of a liquid crystal display element according to the present invention.

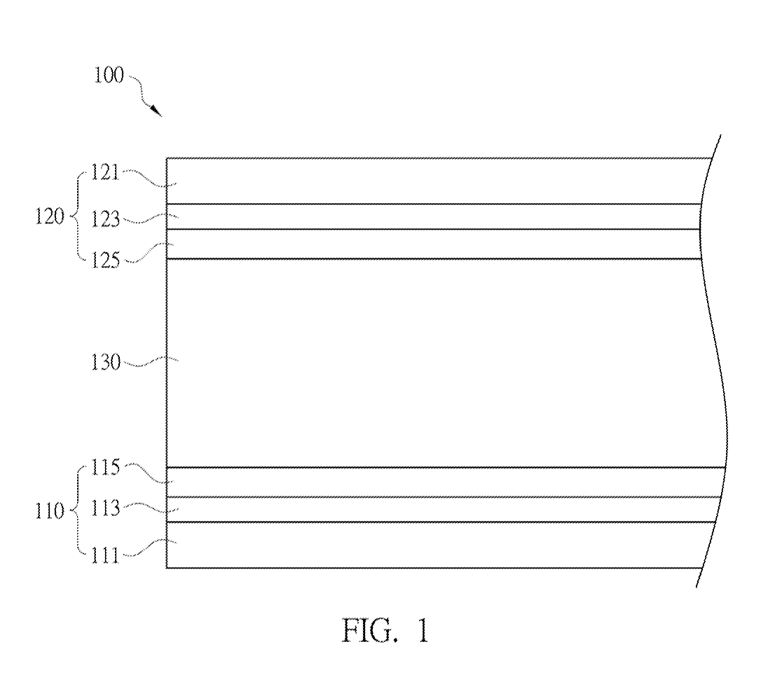

### DETAILED DESCRIPTION

### Producing Polymer Composition (A)

Hereinafter, the polymer composition (A) of Synthesis Examples A-1-1 to A-2-10 and Comparative Synthesis Examples A-3-1 to A-3-6 were according to Table 1 and Table 2 as follows.

### Synthesis Example A-1-1

A 500 ml four-necked conical flask equipped with a nitrogen inlet, a stirrer, a condenser and a thermometer was purged with nitrogen. Then, 0.9 g (0.005 mole) of 2,4-diaminophenylacetic acid methyl ester (hereinafter abbreviated as b-1-1), 2.96 g (0.0075 mole) of the aforementioned diamine compound (b-2-1) having a structure of formula (II-11) (hereinafter abbreviated as b-2-1), 4.05 g (0.0375 mole) p-diaminobenzene (hereinafter abbreviated as b-3-1) and 80 g of N-methyl-2-pyrrolidinone (hereinafter abbreviated as NMP) were added. Next, 10.91 g (0.05 mole) of pyromellitic dianhydride (hereinafter abbreviated as a-1) and 20 g of NMP were added and left to react for 2 hours at room temperature. After the reaction was completed, the reacting solution was poured into 1500 ml of water to precipitate a polymer. The polymer obtained after filtering was repeatedly washed using methanol and filtered thrice, and then placed into a vacuum oven, where drying was carried out at 60° C., thereby obtaining a polymer composition (A-1-1). An imidization ratio of the resulted polymer composition (A-1-1) was evaluated according to the following evaluation method, and the result thereof was listed as Table 1. The evaluation method of the imidization ratio was described as follows.

### Synthesis Examples A-1-2 to A-1-5 and Comparative Synthesis Examples A-3-1, A-3-2 and A-3-6

Synthesis Examples A-1-2 to A-1-5 and Comparative Synthesis Examples A-3-1, A-3-2 and A-3-6 were practiced with the same method as in Synthesis Example A-1-1 by using various kinds or amounts of the compositions for the polymer composition. The formulations and detection results thereof were listed in Table 1 and Table 2 rather than focusing or mentioning them in details.

### Synthesis Example A-2-1

A 500 ml four-necked conical flask equipped with a nitrogen inlet, a stirrer, a heater, a condenser and a thermometer was purged with nitrogen. Then, 0.9 g (0.005 mole) of b-1-1, 2.96 g (0.0075 mole) of b-2-1, 4.05 g (0.0375 mole) of b-3-1 and 80 g of NMP were added. Next, 10.91 g (0.05 mole) of a-1 and 20 g of NMP were added and left to react for 6 hours at room temperature. And then, 97 g of NMP, 2.55 g of acetic anhydride and 19.75 g of pyridine were added at 60° C. and left to stir for 2 hours for imidization reaction. When the reaction is complete, the reacting solution was poured into 1500 ml of water to precipitate the polymer. The polymer obtained after filtering was repeatedly washed using methanol and filtered thrice, and then placed into a vacuum oven, where drying was carried out at 60° C., thereby obtaining a polymer composition (A-2-1). An imidization ratio of the resulted polymer composition (A-2-1) was evaluated according to the following evaluation method, and the result thereof was listed as Table 1. The evaluation method of the imidization ratio was described as follows.

### Synthesis Examples A-2-2 to A-2-10 and Comparative Synthesis Examples A-3-3 to A-3-6

Synthesis Examples A-2-2 to A-2-10 and Comparative Synthesis Examples A-3-3 to A-3-6 were practiced with the same method as in Synthesis Example A-2-1 by using various kinds or amounts of the compositions for the polyimide. The formulations and detection results thereof were listed in Table 1 and Table 2 rather than focusing or mentioning them in details.

### Producing Liquid Crystal Alignment Agent

Hereinafter, the liquid crystal alignment agent of Examples 1 to 15 and Comparative Examples 1 to 6 were according to Table 3 and Table 4 as follows.

### Example 1

100 parts by weight of the polymer (A-1-1) was added into 1200 parts by weight of N-methyl-2-pyrrolidinone (hereinafter abbreviated as B-1) and 600 parts by weight of ethylene glycol n-butyl ether (hereinafter abbreviated as B-2) for mixing in a mixer until all compositions were mixed uniformly at room temperature, thereby obtaining the liquid crystal alignment agent of Example 1. The resulted liquid crystal alignment agent was evaluated according to the following evaluation method, and the result thereof was listed as Table 1. The evaluation methods of the long-term printability was described as follows.

### Examples 2 to 15 and Comparative Examples 1 to 6

Examples 2 to 15 and Comparative Examples 1 to 6 were practiced with the same method as in Example 1 by using various kinds or amounts of the compositions for the liquid crystal alignment agent. The formulations and detection results thereof were listed in Table 3 and Table 4 rather than focusing or mentioning them in details.

### Evaluation Methods

### 1. Imidization Ratio

The imidization ratio refers to a ratio of the number of imide ring in the total amount of the number of amic acid functional group and the number of imide ring, and the imidization ratio is presented by percentage.

After the aforementioned method of reduced pressure drying is performed, the polymer composition (A) of Synthesis Examples A-1-1 to A-2-10 and Comparative Synthesis Examples A-3-1 to A-3-6 respectively were dissolved in a suitable deuteration solvent, such as dimethyl sulfoxide. ¹H-NMR (hydrogen-nuclear magnetic resonance) was detected at room temperature (25° C.) using tetramethylsilane as a standard, and the imidization ratio (%) was calculated according to the following formula (VII):

$$Imidization Ratio ( \% ) = [ 1 - \frac{Δ 1}{Δ 2 \times α} ] \times 100 \% \qquad ( VII )$$

in the formula (VII), Δ1 is the peak area of the chemical shift induced by the proton of NH group near 10 ppm, Δ2 is the peak area of other proton, and α is the ratio of one proton of NH group corresponding to the number of other proton in the polyamic acid precursor.

### 2. Long-Term Printability

The long-term printability of the liquid crystal alignment agent of the aforementioned Examples 1 to 15 and Comparative Examples 1 to 6 was evaluated by a printer (made by Nissha Printing Co. LTD., and the trade name is Angstromer S-15). Printing plates of the printer were 400-mesh APR plates, and the printing plates were printed based on 3.6 mm nip width every 5 seconds of tack time. In the evaluating method of the long-term printability, the liquid crystal alignment agent was printed on a glass substrate, and the glass substrate is 100 mm×100 mm. Next, idling printing (referred to as the liquid crystal alignment agent was directly printed by a printing platform without the glass substrate) was performed five times. Then, the liquid crystal alignment agent was printed on ten glass substrates, the ten glass substrates were 100 mm×100 mm, and the tenth glass substrate where the liquid crystal alignment agent has been printed was disposed on a heating plate. The aforementioned tenth glass substrate was heated at 70° C. for two mins to obtain a coating film. And then, a surface of the coating film was objected by a microscope of 50 scale to determine printing defects of the liquid crystal alignment agent was accumulated or particles were precipitated, and an evaluation was made according to the following criterion:

⊚: the liquid crystal alignment agent did not accumulate on the surface, and the particles did not precipitate

◯: some of the liquid crystal alignment agent were accumulated on the surface, and the particles did not precipitate

Δ: a large amount of the liquid crystal alignment agent were accumulated on the surface, and the particles did not precipitate

X: a large amount of the liquid crystal alignment agent were accumulated on the surface, and the particles were precipitate

According to Table 3 and Table 4, when the liquid crystal alignment comprises the diamine compound (b-1) and the diamine compound (b-2), the liquid crystal alignment has an excellent long-term printability.

Moreover, when the molar ratio of the diamine compound (b-1) and the diamine compound (b-2) is 0.15 to 3.0, the diamine component (b) can further improve the long-term printability of the liquid crystal alignment.

It should be supplemented that, although specific compounds, components, specific reactive conditions, specific processes, specific evaluation methods or specific equipments are employed as exemplary embodiments of the present invention, for illustrating the liquid crystal alignment agent, the liquid crystal alignment film and the liquid crystal display element having thereof of the present invention. However, as is understood by a person skilled in the art instead of limiting to the aforementioned examples, the liquid crystal alignment agent, the liquid crystal alignment film and the liquid crystal display element having thereof of the present invention also can be manufactured by using other compounds, components, reactive conditions, processes, analysis methods and equipment without departing from the spirit and scope of the present invention.

As is understood by a person skilled in the art, the foregoing preferred embodiments of the present invention are illustrated of the present invention rather than limiting of the present invention. In view of the foregoing, it is intended to cover various modifications and similar arrangements included within the spirit and scope of the appended claims. Therefore, the scope of which should be accorded the broadest interpretation so as to encompass all such modifications and similar structure.

TABLE 1

| | | | Synthesis Example | | | | | | | |
|---|---|---|---|---|---|---|---|---|---|---|
| Compositions (mole %) | | | A-1-1 | A-1-2 | A-1-3 | A-1-4 | A-1-5 | A-2-1 | A-2-2 | A-2-3 |
| Tetracarboxylic Dianhydride | | a-1-1 | 100 | | | 100 | | 100 | | |
| Component (a) | | a-1-2 | | 100 | 50 | | | | 100 | 50 |
| | | a-1-3 | | | 50 | | 100 | | | 50 |
| Diamine | Diamine | b-1-1 | 10 | | | | | 10 | | |
| Component (b) | Compound | b-1-2 | | 20 | 5 | | 15 | | 20 | 5 |
| | (b-1) | b-1-3 | | | | 50 | 15 | | | |
| | Diamine | b-2-1 | 15 | | | | | 15 | | |
| | Compound | b-2-2 | | 50 | | | | | 50 | |
| | (b-2) | b-2-3 | | | 30 | | | | | 30 |
| | | b-2-4 | | | | 10 | | | | |
| | | b-2-5 | | | | 7 | 40 | | | |
| | Diamine | b-3-1 | 75 | | | | | 75 | | |
| | Compound | b-3-2 | | 30 | 15 | 33 | | | 30 | 15 |
| | (b-3) | b-3-3 | | | 50 | | | | | 50 |
| | | b-3-4 | | | | | 30 | | | |

| | | | | | | | | |
|---|---|---|---|---|---|---|---|---|
| Molar Ratio of (b-1)/(b-2) | 0.67 | 0.40 | 0.17 | 2.94 | 0.75 | 0.67 | 0.40 | 0.17 |
| Imidization Ratio (%) | 0 | 0 | 0 | 0 | 0 | 12 | 23 | 28 |

| | | | Synthesis Example | | | | | | |
|---|---|---|---|---|---|---|---|---|---|
| Compositions (mole %) | | | A-2-4 | A-2-5 | A-2-6 | A-2-7 | A-2-8 | A-2-9 | A-2-10 |
| Tetracarboxylic Dianhydride | | a-1-1 | 100 | | | 50 | | | 50 |
| Component (a) | | a-1-2 | | | 100 | 50 | | 100 | |
| | | a-1-3 | | 100 | | | 100 | | 50 |
| Diamine | Diamine | b-1-1 | | | 3 | 50 | | | |
| Component (b) | Compound | b-1-2 | | 15 | 3 | | 30 | 20 | 5 |
| | (b-1) | b-1-3 | 50 | 15 | | | | 20 | |
| | Diamine | b-2-1 | | | | 10 | | | |
| | Compound | b-2-2 | | | 40 | 5 | | | |
| | (b-2) | b-2-3 | | | | | 10 | | 40 |
| | | b-2-4 | 10 | | | | | | 10 |
| | | b-2-5 | 7 | 40 | | | 10 | 15 | |
| | Diamine | b-3-1 | | | 55 | | | 25 | |
| | Compound | b-3-2 | 33 | | | | 50 | | 45 |
| | (b-3) | b-3-3 | | | | 35 | | 20 | |
| | | b-3-4 | | 30 | | | | | |

| | | | | | | | |
|---|---|---|---|---|---|---|---|
| Molar Ratio of (b-1)/(b-2) | 2.94 | 0.75 | 0.15 | 3.33 | 1.50 | 2.67 | 0.10 |
| Imidization Ratio (%) | 30 | 42 | 51 | 63 | 78 | 90 | 93 |

a-1 pyromellitic dianhydride
a-2 1,2,3,4-cyclobutane tetracarboxylic dianhydride
a-3 3,4-dicarboxy-1,2,3,4-tetrahydronaphthalene-1-succinic acid dianhydride
b-1-1 2,4-diaminophenylacetic acid methyl ester
b-1-2 3,5-diaminophenylacetic acid ethyl ester
b-1-3 1,3-diamino-4-(2-butoxyethyl)benzene
b-2-1 diamine compound having a structure of formula (II-11)
b-2-2 diamine compound having a structure of formula (II-3)
b-2-3 diamine compound having a structure of formula (II-10)
b-2-4 diamine compound having a structure of formula (III-12)
b-2-5 diamine compound having a structure of formula (III-13)
b-3-1 p-diaminobenzene
b-3-2 4,4′-diaminodiphenylmethane
b-3-3 4,4′-diaminodiphenylether
b-3-4 5-[4-(4-n-pentylcyclohexyl)cyclohexyl]phenylmethylene-1,3-diaminobenzene

TABLE 2

| | | | Comparative Synthesis Example | | | | | |
|---|---|---|---|---|---|---|---|---|
| Compositions (mole %) | | | A-3-1 | A-3-2 | A-3-3 | A-3-4 | A-3-5 | A-3-6 |
| Tetracarboxylic | | a-1 | 100 | 100 | | | | 100 |
| Dianhydride | | a-2 | | | 100 | | 100 | |
| Component (a) | | a-3 | | | | 100 | | |
| Diamine | Diamine | b-1-1 | | | | | | |
| Component | Compound | b-1-2 | | | | 20 | | |
| (b) | (b-1) | b-1-3 | | 50 | | | | |
| | Diamine | b-2-1 | 15 | | | | | |
| | Compound | b-2-2 | | | 40 | | | |
| | (b-2) | b-2-3 | | | | | | |
| | | b-2-4 | | | | | | |
| | | b-2-5 | | | | | | |
| | Diamine | b-3-1 | 85 | | 60 | | 25 | |
| | Compound | b-3-2 | | 50 | | 80 | | |
| | (b-3) | b-3-3 | | | | | 75 | |
| | | b-3-4 | | | | | | 100 |

| | | | | | | |
|---|---|---|---|---|---|---|
| Molar Ratio (b-1)/(b-2) | 0 | — | 0 | — | — | — |
| imidization Ratio (%) | 0 | 0 | 51 | 78 | 90 | 0 |

a-1 pyromellitic dianhydride
a-2 1,2,3,4-cyclobutane tetracarboxylic dianhydride
a-3 3,4-dicarboxy-1,2,3,4-tetrahydronaphthalene-1-succinic acid dianhydride
b-1-1 2,4-diaminophenylacetic acid methyl ester
b-1-2 3,5-diaminophenylacetic acid ethyl ester
b-1-3 1,3-diamino-4-(2-butoxyethyl)benzene
b-2-1 diamine compound having a structure of formula (II-11)
b-2-2 diamine compound having a structure of formula (II-3)
b-2-3 diamine compound having a structure of formula (II-10)
b-2-4 diamine compound having a structure of formula (III-12)
b-2-5 diamine compound having a structure of formula (III-13)
b-3-1 p-diaminobenzene
b-3-2 4,4′-diaminodiphenylmethane
b-3-3 4,4′-diaminodiphenylether
b-3-4 5-[4-(4-n-pentylcyclohexyl) cyclohexyl] phenyl methylene-1,3-diamino benzene

TABLE 3

| Compostion | | Example | | | | | | | | | | | | | | |
|---|---|---|---|---|---|---|---|---|---|---|---|---|---|---|---|---|
| (Parts by Weight) | | 1 | 2 | 3 | 4 | 5 | 6 | 7 | 8 | 9 | 10 | 11 | 12 | 13 | 14 | 15 |
| Polymer | A-1-1 | 100 | | | | | | | | | | | | | | |
| Composition | A-1-2 | | 100 | | | | | | | | | | | | | |
| (A) | A-1-3 | | | 100 | | | | | | | | | | | | |
| | A-1-4 | | | | 100 | | | | | | | | | | | |
| | A-1-5 | | | | | 100 | | | | | | | | | | |
| | A-2-1 | | | | | | 100 | | | | | | | | | |
| | A-2-2 | | | | | | | 100 | | | | | | | | |
| | A-2-3 | | | | | | | | 100 | | | | | | | |
| | A-2-4 | | | | | | | | | 100 | | | | | | |
| | A-2-5 | | | | | | | | | | 100 | | | | | |
| | A-2-6 | | | | | | | | | | | 100 | | | | |
| | A-2-7 | | | | | | | | | | | | 100 | | | |
| | A-2-8 | | | | | | | | | | | | | 100 | 50 | |
| | A-2-9 | | | | | | | | | | | | | | 50 | |
| | A-2-10 | | | | | | | | | | | | | | | 100 |
| | A-3-1 | | | | | | | | | | | | | | | |
| | A-3-2 | | | | | | | | | | | | | | | |
| | A-3-3 | | | | | | | | | | | | | | | |
| | A-3-4 | | | | | | | | | | | | | | | |
| | A-3-5 | | | | | | | | | | | | | | | |
| | A-3-6 | | | | | | | | | | | | | | | |
| Solvent (B) | B-1 | 1200 | | 800 | | | 1000 | 900 | 850 | 1400 | | | 800 | 400 | | 1200 |
| | B-2 | 600 | 1600 | | 800 | 1500 | | 300 | 850 | | 1000 | | 750 | 400 | 1200 | 600 |
| | B-3 | | | 1000 | 800 | 100 | 600 | 300 | | | 350 | 1500 | | 400 | 250 | |
| Additive (C) | C-1 | | | | | | | | | 5 | | | 3 | | | |
| | C-2 | | | | 10 | | | | | | | | 3 | | | 2 |
| Evaluation | Long-term | ⊚ | ⊚ | ⊚ | ⊚ | ⊚ | ⊚ | ⊚ | ⊚ | ⊚ | ⊚ | ⊚ | ◯ | ⊚ | ⊚ | ◯ |
| Method | Printability | | | | | | | | | | | | | | | |

B-1 N-methyl-2-pyrrolidinone
B-2 ethylene glycol n-butyl ether
B-3 N,N-dimethylacetamide
C-1 N,N,N′,N′-tetraglycidyl-4,4′-diaminodiphenylmethane
C-2 N,N-glycidyl-p-glycidoxy aniline

TABLE 4

| Composition | | Comparative Example | | | | | |
|---|---|---|---|---|---|---|---|
| (Parts by Weight) | | 1 | 2 | 3 | 4 | 5 | 6 |
| Polymer | A-1-1 | | | | | | |
| Composition | A-1-2 | | | | | | |
| (A) | A-1-3 | | | | | | |
| | A-1-4 | | | | | | |
| | A-1-5 | | | | | | |
| | A-2-1 | | | | | | |
| | A-2-2 | | | | | | |
| | A-2-3 | | | | | | |
| | A-2-4 | | | | | | |
| | A-2-5 | | | | | | |
| | A-2-6 | | | | | | |
| | A-2-7 | | | | | | |
| | A-2-8 | | | | | | |
| | A-2-9 | | | | | | |
| | A-2-10 | | | | | | |
| | A-3-1 | 100 | | | | | |
| | A-3-2 | | 100 | | | | |
| | A-3-3 | | | 100 | | | |
| | A-3-4 | | | | 100 | | |
| | A-3-5 | | | | | 100 | |
| | A-3-6 | | | | | | 100 |
| Solvent (B) | B-1 | 1200 | | | 400 | | 1200 |
| | B-2 | 600 | 800 | | 400 | 1200 | 800 |
| | B-3 | | 800 | 1500 | 400 | 250 | |
| Additive (C) | C-1 | | | | | | |
| | C-2 | | 10 | | | | |
| Evaluation | Long-term | X | X | X | X | X | X |
| Method | Printability | | | | | | |

B-1 N-methyl-2-pyrrolidinone
B-2 ethylene glycol n-butyl ether
B-3 N,N-dimethylacetamide
C-1 N,N,N′,N′-tetraglycidyl-4,4′-diaminodiphenylmethane
C-2 N,N-glycidyl-p-glycidoxy aniline

What is claimed is:

1. A liquid crystal alignment, comprising:
a polymer composition (A), synthesized by reacting a mixture that includes a tetracarboxylic dianhydride component (a) and a diamine component (b); and
a solvent (B); and
wherein the diamine component (b) includes at least one diamine compound (b-1) having a structure of formula (I), at least one diamine compound (b-2) having a group consisting of a structure of formula (II) to (III) to and an other diamine compound (b-3): 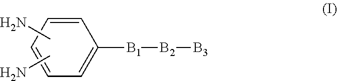
in the formula (I), B₁ is an alkylene group of 1 to 6 carbons; B₂ is 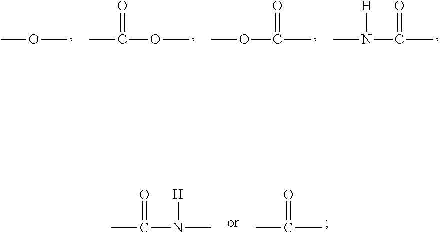
B₃ is an alkyl group of 1 to 6 carbons, an alkoxy group of 1 to 6 carbons, an alkenyl group of 1 to 6 carbons, an aryl group of 6 to 20 carbons or an aralkyl group of 7 to 20 carbons; 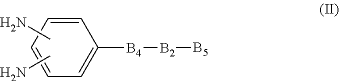
in the formula (II), B₂ is the same as above; B₄ is an alkylene group, a haloalkylene group of 1 to 12 carbons; B₅ is a steroid-containing group, a structure of formula (II-1) or —B₅₁—B₂—B₅₂, wherein B₅₁ is an alkylene group of 1 to 10 carbons and B₅₂ is a steroid-containing group or has a structure of formula (II-1): 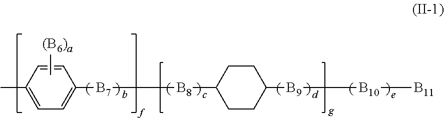
in the formula (II-1), B₆ is a hydrogen atom, a fluoro atom or a methyl group; B₇, B₈ and B₉ respectively are a single bond, 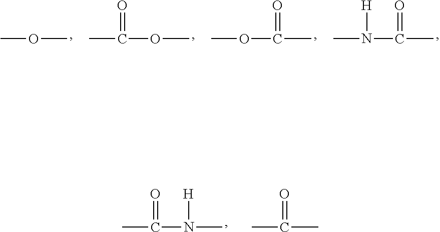
or an alkylene group of 1 to 3 carbons;
B₁₀ is 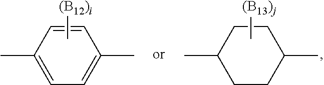
wherein B₁₂ and B₁₃ respectively are a hydrogen atom, a fluoro atom or a methyl group;
B₁₁ is a hydrogen atom, a fluoro atom, an alkyl group of 1 to 12 carbons, a fluoroalkyl group of 1 to 12, an alkoxyl group of 1 to 12 carbons, —OCH₂F, —OCHF₂ or —OCF₃; a is 1 or 2; b, c and d respectively are an integer of 0 to 4; e, f and g respectively are an integer of 0 to 3, and e+f+g≧1; i and j respectively are 1 or 2; when B₆, B₇, B₈, B₉, B₁₀, B₁₁, B₁₂ or B₁₃ are pluralities, B₆, B₇, B₈, B₉, B₁₀, B₁₁, B₁₂ or B₁₃ respectively are the same or different; 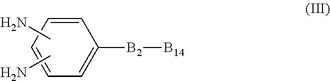
in the formula (III), B₂ is the same as above, and B₁₄ has a structure of formula (III-1): 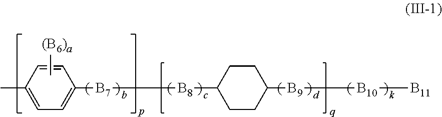
in the formula (III-1), k, p and q respectively are an integer of 0 to 3, and k+p+q≧3.

2. The liquid crystal alignment of claim 1, based on the diamine component (b) as 100 mole, an amount of the diamine compound (b-1) is 5 mole to 50 mole, an amount of the diamine compound (b-2) is 15 mole to 50 mole, and an amount of the other diamine compound (b-3) is 1 mole to 80 mole.

3. The liquid crystal alignment of claim 1, wherein a molar ratio [(b-1)/(b-2)] of the diamine compound (b-1) and the diamine compound (b-2) is 0.15 to 3.0.

4. The liquid crystal alignment of claim 1, wherein the molar ratio [(b-1)/(b-2)] of the diamine compound (b-1) and the diamine compound (b-2) is 0.18 to 2.8.

5. The liquid crystal alignment of claim 1, wherein the molar ratio [(b-1)/(b-2)] of the diamine compound (b-1) and the diamine compound (b-2) is 0.2 to 2.5.

6. The liquid crystal alignment of claim 1, wherein in the formula (I), B₂ is

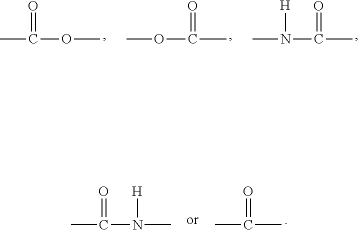

7. The liquid crystal alignment of claim 1, wherein an imidization ratio is 30% to 90%.

8. A liquid crystal alignment film formed by the liquid crystal alignment of claim 1.

9. A liquid crystal display element comprising a liquid crystal alignment film of claim 8.
